(19) United States
(12) Patent Application Publication
(10) Pub. No.: US 2026/0330222 A1
(43) Pub. Date: Oct. 22, 2026

(54) Methods and Systems for De-Biasing A Diffusion Model

(71) Applicant: Mastercard International Incorporated, Purchase, NY (US)

(72) Inventors: Ruma Roy, Gurgaon (IN); Darshika Tiwari, Gurgaon (IN)

(21) Appl. No.: 19/641,092

(22) Filed: Apr. 7, 2026

(30) Foreign Application Priority Data
Apr. 17, 2025 (IN) 202541037351

(51) Int. Cl. G06N 3/08

(52) U.S. Cl. CPC G06N 3/08

(57) ABSTRACT

Methods and systems de-biasing a diffusion model are disclosed. The method performed by a server system includes accessing a set of records and training a diffusion model initialized based on model parameters for training epochs by performing forward process and reverse process. Performing during each training epoch: the forward process for each record including: obtaining a combined embedding; identifying distributed record set; selecting a corresponding combined embedding of a randomly selected record from the corresponding distributed record set and generating blended embedding for the record; and generating a series of noisy embeddings based on the blended embedding and combined embedding; the reverse process for each record to obtain an error for each denoised embedding for each record; and optimize the set of model parameters of the diffusion model based on the error for each denoised embedding for the record.

### TECHNICAL FIELD

The present disclosure relates to artificial intelligence-based processing systems and, more particularly, to electronic methods and complex processing systems for debiasing a diffusion model.

### BACKGROUND

The increasing adoption of generative models, such as diffusion models, in various domains has significantly advanced the generation of synthetic data. Initially, the diffusion models such as Denoising Diffusion Probabilistic Model (DDPM) are popularized in image and text synthesis. The DDPM generates high-quality output by iteratively denoising Gaussian noise through a learned reverse process. The diffusion models have recently been adapted for tabular data due to their ability to model complex feature interdependencies and generate diverse and realistic outputs. These models operate via a forward-noising and reverse-denoising process, making them robust and stable alternatives to traditional Generative Adversarial Networks (GANs) and Variational Autoencoders (VAEs).

With the expansion of the generative models into sensitive domains such as healthcare, criminal justice, and finance, concerns regarding fairness in synthetic data generation have come to the forefront. The diffusion models trained on real-world datasets are prone to inheriting and amplifying bias embedded in the training data. Herein, the term ‘bias’ indicates systematic disparities in the training data that can lead the diffusion models to generate synthetic data that unfairly favors or disfavors certain groups. For instance, they may disproportionately favor outcomes for specific demographic groups over others, thereby exacerbating social inequities. The bias persists in the synthetic data generated by the diffusion models, leading to unfair representation across sensitive attributes such as race, gender, and age.

Thus, a technological need exists for improved methods and systems for de-biasing the diffusion models for generating the synthetic data that has reduced bias.

### SUMMARY

Various implementations of the present disclosure provide methods, systems, electronic devices, and computer program products for de-biasing a diffusion model.

In an implementation, a computer-implemented method for de-biasing a diffusion model is disclosed. The computer-implemented method performed by a server system includes accessing a set of records. Each record in the set of records includes a set of first attributes, and a set of second attributes. Further, the computer-implemented method includes training a diffusion model initialized based on a set of model parameters for a plurality of training epochs by performing a forward process and a reverse process. Performing during each training epoch: the forward process for each record, the forward process including: obtaining a combined embedding of the record; identifying a distributed record set associated with the record; selecting a corresponding combined embedding of a randomly selected record from the corresponding distributed record set of the identified distributed record set; generating a blended embedding for the record based, at least in part, on the combined embedding of the record and the corresponding combined embedding of the randomly selected record; generating a series of noisy embeddings based, at least in part, on progressively adding noise to the blended embedding for the record during an initial plurality of timesteps, and subsequently progressively adding noise to the combined embedding for the record for remaining timesteps, each noisy embedding in the series of noisy embedding associated with a particular timestep from the plurality of timesteps. Further, performing during each training epoch: the reverse process for each record to obtain an error for each denoised embedding for each record; and optimizing the set of model parameters of the diffusion model based, at least in part, on the error for each denoised embedding for the record. Further, the computer-implemented method includes obtaining a trained diffusion model after the plurality of training epochs.

In another implementation, a server system is disclosed. The server system includes a communication interface and a memory including executable instructions. The server system also includes a processor communicably coupled to the communication interface and the memory. The processor is configured to execute the instructions to cause the server system, at least in part, to access a set of records. Each record in the set of records includes a set of first attributes, and a set of second attributes. Further, the server system is caused to train a diffusion model initialized based on a set of model parameters for a plurality of training epochs by performing a forward process and a reverse process. Performing during each training epoch: the forward process for each record, the forward process including: obtaining a combined embedding of the record; identifying a distributed record set associated with the record; selecting a corresponding combined embedding of a randomly selected record from the corresponding distributed record set of the identified distributed record set; generating a blended embedding for the record based, at least in part, on the combined embedding of the record and the corresponding combined embedding of the randomly selected record; generating a series of noisy embeddings based, at least in part, on progressively adding noise to the blended embedding for the record during an initial plurality of timesteps, and subsequently progressively adding noise to the combined embedding for the record for remaining timesteps, each noisy embedding in the series of noisy embedding associated with a particular timestep from the plurality of timesteps. Further, performing during each training epoch: the reverse process for each record to obtain an error for each denoised embedding for each record; and optimizing the set of model parameters of the diffusion model based, at least in part, on the error for each denoised embedding for the record. Further, the server system is caused to obtain a trained diffusion model after the plurality of training epochs.

In yet another implementation, a non-transitory computer-readable storage medium is disclosed. The non-transitory computer-readable storage medium includes computer-executable instructions that, when executed by at least a processor of a server system, cause the server system to perform a method. The method includes accessing a set of records. Each record in the set of records includes a set of first attributes, and a set of second attributes. Further, the method includes training a diffusion model initialized based on a set of model parameters for a plurality of training epochs by performing a forward process and a reverse process. Performing during each training epoch: the forward process for each record, the forward process including: obtaining a combined embedding of the record; identifying a distributed record set associated with the record; selecting a corresponding combined embedding of a randomly selected record from the corresponding distributed record set of the identified distributed record set; generating a blended embedding for the record based, at least in part, on the combined embedding of the record and the corresponding combined embedding of the randomly selected record; generating a series of noisy embeddings based, at least in part, on progressively adding noise to the blended embedding for the record during an initial plurality of timesteps, and subsequently progressively adding noise to the combined embedding for the record for remaining timesteps, each noisy embedding in the series of noisy embedding associated with a particular timestep from the plurality of timesteps. Further, performing during each training epoch: the reverse process for each record to obtain an error for each denoised embedding for each record; and optimizing the set of model parameters of the diffusion model based, at least in part, on the error for each denoised embedding for the record. Further, the method includes obtaining a trained diffusion model after the plurality of training epochs.

The foregoing summary is illustrative only and is not intended to be in any way limiting. In addition to the illustrative aspects, implementations, and features described above, further aspects, implementations, and features will become apparent by reference to the drawings and the following detailed description.

### BRIEF DESCRIPTION OF THE FIGURES

For a more complete understanding of example implementations of the present technology, reference is now made to the following descriptions taken in connection with the accompanying drawings in which:

FIG. 1 illustrates a schematic representation of an environment related to at least some example implementations of the present disclosure;

FIG. 2 illustrates a simplified block diagram of a server system, in accordance with an implementation of the present disclosure;

FIG. 3 illustrates a schematic representation of an architecture of a diffusion model, in accordance with an implementation of the present disclosure;

FIG. 4 illustrates t-Distributed Stochastic Neighbor Embedding plots depicting feature distribution of actual positive class dataset and a generated positive class dataset, in accordance with an implementation of the present disclosure;

FIG. 5 illustrates a Linear Discriminant Analysis plot of an adult dataset and a generated dataset, in accordance with an implementation of the present disclosure;

FIG. 6 illustrates a graph depicting accuracy and fairness of synthetic data generated for different generation timestep, in accordance with an implementation of the present disclosure;

FIG. 7 illustrates a process flow diagram depicting a method for generating a combined embedding, in accordance with an implementation of the present disclosure; and

FIG. 8A and FIG. 8B, collectively, illustrate a process flow diagram depicting a training process of a diffusion model, in accordance with an implementation of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. Descriptions of well-known components and processing techniques are omitted so as to not unnecessarily obscure the implementations herein. The examples used herein are intended merely to facilitate an understanding of ways in which the implementations herein may be practiced and to further enable those of skill in the art to practice the implementations herein. Accordingly, the examples should not be construed as limiting the scope of the implementations herein.

Reference in this specification to “one implementation” or “an implementation” means that a particular feature, structure, or characteristic described in connection with the implementation is included in at least one implementation of the present disclosure. The appearances of the phrase “in an implementation” in various places in the specification are not necessarily all referring to the same implementation, nor are separate or alternative implementations mutually exclusive of other implementations. Moreover, various features are described which may be exhibited by some implementations and not by others. Similarly, various requirements are described which may be requirements for some implementations but not for other implementations.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

Implementations of the present disclosure may be embodied as an apparatus, a system, a method, or a computer program product. Accordingly, implementations of the present disclosure may take the form of an entire hardware implementation, an entire software implementation (including firmware, resident software, micro-code, etc.), or an implementation combining software and hardware aspects that may all generally be referred to herein as a “circuit”, “engine”, “module”, or “system”. Furthermore, aspects of the present disclosure may take the form of a computer program product embodied in one or more computer-readable storage media having computer-readable program code embodied thereon.

Unless otherwise explicitly stated, articles such as “a” or “an” should generally be interpreted to include one or more described items. Accordingly, phrases such as “a server system configured to” are intended to include one or more recited server systems/processors. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C. The same holds true for the use of definite articles used to introduce implementation recitations. In addition, even if a specific number of an introduced implementation recitation is explicitly recited, those skilled in the art will recognize that such recitation should typically be interpreted to mean at least the recited number (e.g., the bare recitation of “two recitations” without other modifiers, typically means at least two recitations or two or more recitations).

The terms “account holder”, “user”, “cardholder”, “consumer”, and “buyer” are used interchangeably throughout the description and refer to a person who has a payment account or a payment card (e.g., credit card, debit card, etc.) associated with the payment account, that will be used by them at a merchant to perform a payment transaction. The payment account may be opened via an issuing bank or an issuer.

The term “merchant”, used throughout the description, generally refers to a seller, a retailer, a purchase location, an organization, or any other entity that is in the business of selling goods or providing services, and it can refer to either a single business location or a chain of business locations of the same entity.

The terms “payment network” and “card network” are used interchangeably throughout the description and refer to a network or collection of systems used for the transfer of funds through the use of cash substitutes. Payment networks may use a variety of protocols and procedures in order to process the transfer of money for various types of transactions. Payment networks are networks that connect an issuing bank with an acquiring bank to facilitate online payment. Transactions that may be performed via a payment network may include product or service purchases, credit purchases, debit transactions, fund transfers, account withdrawals, etc. Payment networks may be configured to perform transactions via cash substitutes that may include payment cards, letters of credit, checks, financial accounts, etc. Examples of networks or systems configured to perform or function as payment networks include those operated by payment processors.

The term “payment card”, used throughout the description, refers to a physical or virtual card linked with a financial or payment account that may be presented to a merchant or any such facility to fund a financial transaction via the associated payment account. Examples of the payment card include, but are not limited to, debit cards, credit cards, prepaid cards, virtual payment numbers, virtual card numbers, forex cards, charge cards, e-wallet cards, and stored-value cards. The payment card may be a physical card that may be presented to the merchant for funding the payment. Alternatively, or additionally, the payment card may be embodied in the form of data stored in a user device, where the data is associated with a payment account such that the data can be used to process the financial transaction between the payment account and a merchant's financial account.

The term “payment account”, used throughout the description, refers to a financial account that is used to fund a financial transaction. Examples of the financial account include, but are not limited to, a savings account, a credit account, a checking account, and a virtual payment account. The financial account may be associated with an entity such as an individual person, a family, a commercial entity, a company, a corporation, a governmental entity, a non-profit organization, and the like. In some scenarios, the financial account may be a virtual or temporary payment account that can be mapped or linked to a primary financial account, such as those accounts managed by payment wallet service providers, and the like.

The terms “payment transaction”, “financial transaction”, “event”, and “transaction” are used interchangeably throughout the description and refer to a transaction or transfer of payment of a certain amount being initiated by the cardholder. More specifically, they refer to electronic financial transactions including, for example, online payment, payment at a terminal (e.g., Point of Sale (POS) terminal), and the like. Generally, a payment transaction is performed between two entities, such as a buyer and a seller. It is to be noted that a payment transaction is followed by a payment transfer of a transaction amount (i.e., monetary value) from one entity (e.g., issuing bank associated with the buyer) to another entity (e.g., acquiring bank associated with the seller), in exchange for any goods or services.

The term “sensitive attributes”, used throughout the description, refers to attributes in a dataset that is prone to bias
and require fairness-aware handling. Examples of sensitive attributes include, but are not limited to, race, gender, marital status, demography, and the like.

The term “non-sensitive attributes”, used throughout the description, refers to attributes in the dataset other than the sensitive attributes. Examples of the non-sensitive attributes include, but are not limited to, transaction amount, transaction time, and the like.

The term ‘record’, used throughout the description, refers to a single, structured data entry that represents information about an individual entity or event within a dataset. It typically consists of multiple attributes or fields, where each field holds a value corresponding to a specific property of that entity. Examples of records include, but are not limited to, educational records, healthcare records, employee records, and the like. In the financial domain, the term ‘record’ may refer to transactions.

### Overview

Various implementations of the present disclosure provide methods, systems, electronic devices, and computer program products for de-biasing a diffusion model.

In a non-limiting implementation, the server system is configured to access a set of records. Each record includes a set of first attributes and a set of second attributes. Further, the server system is configured to generate a first embedding for each record based, at least in part, on the set of first attributes. Then, the server system is configured to generate a second embedding based, at least in part, on the set of second attributes. Moreover, the server system is configured to compute a probability density of the set of second attributes associated with each record for the set of records. The probability density is computed based, at least in part, on the second embedding associated with each record. Additionally, the server system is configured to smoothen the second embedding associated with each record based, at least in part, on the probability density. Herein, smoothening the second embedding associated with each record ensures minimal distinguishability between different second attributes associated with each record for the set of records.

Further, the server system is configured to generate a combined embedding for each record based, at least in part, on the corresponding first embedding and the corresponding second embedding. Furthermore, the server system is configured to identify a plurality of second attribute types of the set of second attributes based, at least in part, on the set of records. Further, the server system is configured to segregate the set of records into a plurality of distributed record sets based, at least in part, on the plurality of second attribute types. Herein, each distributed record set includes a subset of records associated with a subset of second attributes of a particular second attribute type. Here, each distributed record set has a corresponding distributed record set, including a distinct subset of records associated with a distinct second attribute type. Furthermore, the server system is configured to train a diffusion model for a plurality of training epochs based, at least in part, on a forward process and a reverse process. Herein, each training epoch includes performing by the diffusion model the forward process for each record. Herein, performing the forward process includes (i) obtaining the combined embedding for the record; (ii) identifying the distributed record set associated with the record; (iii) selecting a combined embedding for a randomly selected record from the corresponding distributed record set of the identified distributed record set; (iv) generating a blended embedding for the record based, at least in part, on the combined embedding of the record and the combined embedding of the randomly selected record; (v) generating a series of noisy embeddings based, at least in part, on progressively adding noise to the blended embedding for the record during an initial plurality of timesteps, and subsequently progressively adding noise to the combined embedding for the record for remaining timesteps. Herein, each noisy embedding in the series of noisy embeddings is associated with a particular timestep from the plurality of timesteps. Each training epoch also includes performing by the diffusion model, the reverse process for each record. Herein, performing the reverse process includes (i) generating a series of denoised embeddings based, at least in part, on progressively denoising each noisy embedding, each denoised embedding in the series of denoised embedding corresponds to each noisy embedding; (ii) computing, by a loss function, an error for each denoised embedding based, at least in part, on the series of denoised embeddings and the series of noisy embeddings. In particular, the diffusion model compares the predicted noise with actual noise added to generate the noisy embedding, and the loss function computes the error based on the comparison between the predicted noise and the actual noise. Further, the server system is configured to optimize a set of model parameters of the diffusion model based, at least in part, on the error corresponding to each denoised embedding for each record. Once the training process is completed after performing the plurality of training epochs, the diffusion model is considered to be trained. Additionally, the server system is configured to obtain a noise distribution from the dataset. Moreover, the server system is configured to perform the reverse process via the diffusion model on the noise distribution to obtain a set of synthetic records.

Various implementations of the present disclosure offer multiple advantages and technical effects. For instance, the proposed approach smoothens a second embedding (i.e., embedding of the sensitive features) associated with each record. This process reduces the distinguishability between different second attributes (i.e., sensitive attributes) across a set of records, thereby minimizing direct bias present in the set of records. After smoothening, the second embedding is combined with the first embedding (i.e., embedding of categorical attributes) to form a combined embedding. During training, a diffusion model utilizes combined embeddings of two records having distinct second attribute types to generate a blended embedding. This intermixing of embeddings contributes to the minimization of any inherent bias present in the set of records. Consequently, the diffusion model, trained using such combined embeddings, becomes capable of generating unbiased synthetic data, thereby ensuring fairness and improved generalization in downstream applications. Herein, the term “unbiased synthetic data” refers to a synthetic set of records (or synthetic records) that has minimized the bias (i.e., it is associated with improved fairness related metrics) compared to traditional synthetic records created using traditional existing approaches.

Considering an exemplary scenario of a healthcare environment. A healthcare provider may use a patient dataset to train a classifier for identifying individuals with liver cirrhosis. However, due to class imbalance, specifically a higher number of first-gender samples, the classifier tends to produce biased outputs. To address this imbalance, the health care provider employs diffusion models trained on the existing patient data to generate synthetic samples, aiming to supplement the minority class. However, since the diffusion models are trained on biased data, they end up amplifying the existing bias. As a result, even though class imbalance is addressed, the samples in the dataset remain biased, which can further degrade the performance of the classifier.

Now, to enhance the classification process, an application of the approach provided by the various implementations described herein can be utilized. The proposed approach generates a first embedding based on the set of first attributes (i.e., non-sensitive attributes) present in the patient dataset. Further, the proposed approach generates a second embedding based on the set of second attributes (i.e., sensitive attributes such as gender) present in the patient dataset. Further, the proposed approach computes a probability density of the second attributes associated with each patient record based on the second embedding associated with each patient record. Then, the proposed approach smoothens the second embedding associated with each record based on the probability density. This process ensures minimal distinguishability between different patient records irrespective of gender, thereby minimizing the direct bias present in the patient data. Further, the proposed approach generates a combined embedding based on the corresponding first embedding and the corresponding second embedding.

Further, the proposed approach identifies and segregates patient records that belong to male patients and female patients. Then, the proposed approach trains a diffusion model for a plurality of training epochs. During each epoch, the diffusion model performs a set of operations for each patient record. The set of operations can include obtaining the combined embedding associated with a particular record. Then, the proposed approach identifies whether the particular record belongs to a male patient or a female patient. If it belongs to a male patient, the proposed approach selects a combined embedding associated with a female patient and blends it with the combined embedding and vice versa. This will generate a blended embedding. This blended embedding is utilized by the diffusion model to generate a series of noisy embeddings by progressively adding noise to the blended embedding for the record during an initial plurality of timesteps, and subsequently progressively adding noise to the combined embedding for the record for remaining timesteps. The diffusion model generates a series of denoised embeddings by progressive denoising each noisy embedding. Here, the diffusion model computes a predicted noise associated with each noisy embedding and uses the predicted noise to obtain the denoised embedding corresponding to a preceding timestep. During this process, a loss function may be computed, and using the loss function, the model parameters of the diffusion model are optimized. It is to be noted that, by intermixing the combined embedding of the patient records belonging to patients of different genders, the inherent bias present in the patient dataset gets minimized.

To that end, the diffusion model trained using these blended embeddings will have minimal bias and are capable of generating fair synthetic data using the noise distribution. This fair synthetic data can be used to augment the patient dataset to eliminate the class imbalance, hence improving the classification performance of the classifier.

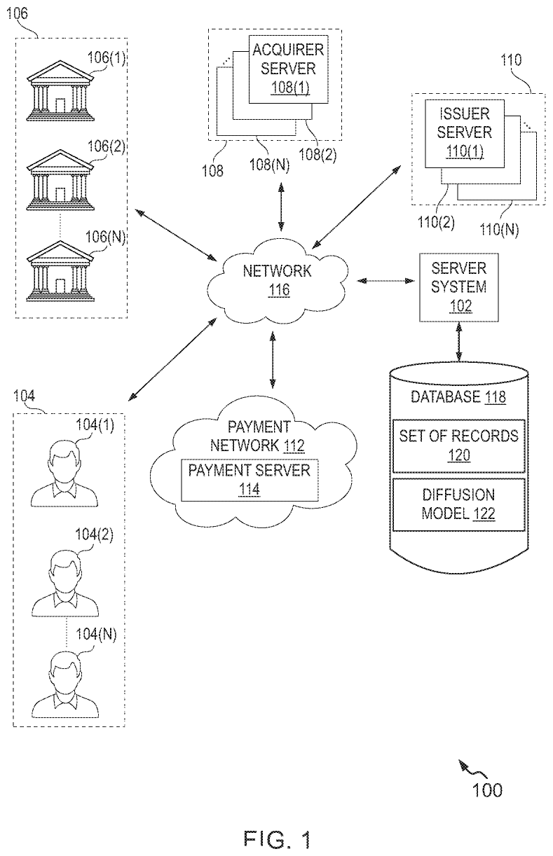

Various example implementations of the present disclosure are described hereinafter with reference to FIG. 1 to FIGS. 8A-8B.

FIG. 1 illustrates an exemplary representation of an environment 100 related to at least some implementations of the present disclosure. Although the environment 100 is presented in one arrangement, other implementations may include the parts of the environment 100 (or other parts) arranged otherwise depending on, for example, de-biasing a diffusion model 122 and the like.

The environment 100 generally includes a plurality of components such as a server system 102, a payment network 112 including a payment server 114, a database 118, a plurality of entities such as a plurality of cardholders 104(1), 104(2), . . . 104(N) (collectively, referred to as the ‘plurality of cardholders 104’, where ‘N’ is a Natural number), a plurality of merchants 106(1), 106(2), . . . , 106(N) (collectively, referred to as the ‘plurality of merchants 106’ and ‘N’ is a Natural number), a plurality of acquirers 108(1), 108(2), . . . , 108(N) (collectively, referred to as the ‘plurality of acquirers 108’ and ‘N’ is a Natural number), a plurality of issuers 110(1), 110(2), . . . , 110(N) (collectively, referred to as the ‘plurality of issuers 110’ and ‘N’ is a Natural number), a set of records 120, and the diffusion model 122 each coupled to, and in communication with (and/or with access to) a network 116. Herein, the payment network 112 indicates a network that connects an issuing bank with an acquiring bank to facilitate payment, and the payment server 114 is responsible for facilitating the various operations of the payment network 112.

It is noted that these entities may be classified or segregated based, at least in part, on their relationship in the payment network 112 or the network 116 with each other in the payment ecosystem. The network 116 may include, without limitation, a Light Fidelity (Li-Fi) network, a Local Area Network (LAN), a Wide Area Network (WAN), a Metropolitan Area Network (MAN), a satellite network, the Internet, a fiber optic network, a coaxial cable network, an Infrared (IR) network, a Radio Frequency (RF) network, a virtual network, and/or another suitable public and/or private network capable of supporting communication among two or more of the parts or users illustrated in FIG. 1, or any combination thereof.

Various entities in the environment 100 may connect to the network 116 in accordance with various wired and wireless communication protocols, such as Transmission Control Protocol/Internet Protocol (TCP/IP), User Datagram Protocol (UDP), 2nd Generation (2G), 3rd Generation (3G), 4th Generation (4G), 5th Generation (5G) communication protocols, Long Term Evolution (LTE) communication protocols, future communication protocols or any combination thereof. For example, the network 116 may include multiple different networks, such as a private network made accessible by the server system 102 and a public network (e.g., the Internet, etc.) through which the server system 102, the plurality of acquirers 108, the plurality of issuers 110, and the payment server 114 may communicate.

In an implementation, the plurality of cardholders 104 (or cardholders 104) uses one or more payment cards to make payment transactions at the plurality of merchants 106 (or merchants 106). A cardholder (e.g., the cardholder 104(1)) may be any individual, representative of a corporate entity, a non-profit organization, or any other person that is presenting payment account details during an electronic payment transaction with a merchant (e.g., the merchant 106(1)). The cardholder (e.g., the cardholder 104(1)) may have a payment account issued by an issuing bank (not shown in figures) associated with an issuer 110(1) from the plurality of the issuers 110(explained later) and may be provided a payment card with financial or other account information encoded onto the payment card such that the cardholder (i.e., the cardholder 104(1)) may use the payment card to initiate and complete a payment transaction using a bank account at the issuing bank.

In an example, the cardholders 104 may use their corresponding electronic devices (not shown) to access a mobile application or a website associated with the issuing bank or any third-party payment application. In various non-limiting examples, electronic devices may refer to any electronic devices such as, but not limited to, Personal Computers (PCs), tablet devices, Personal Digital Assistants (PDAs), voice-activated assistants, Virtual Reality (VR) devices, smartphones, and laptops.

In an implementation, the merchants 106 may include retail shops, restaurants, supermarkets or establishments, government and/or private agencies, or any such places equipped with POS terminals, where an individual such as the cardholders 104, visit to perform the financial transaction in exchange for any goods and/or services or any financial transactions.

In one scenario, the cardholders 104 may use their corresponding payment accounts or payment cards to conduct payment transactions with the merchants 106. Moreover, it may be noted that each of the cardholders 104 may use their corresponding payment card from the payment cards differently or make the payment transaction using different means of payment. For instance, the cardholder 104(1) may enter payment account details on an electronic device (not shown) associated with the cardholder 104(1) to perform an online payment transaction. In another example, the cardholder 104(2) may utilize the payment card to perform an offline payment transaction. For example, the cardholder 104(1) may enter details of the payment card to transfer funds in the form of cash currency on an e-commerce platform to buy goods. In another instance, each cardholder (e.g., the cardholder 104(1)) of the cardholders 104 may transact at any merchant (e.g., the merchant 106(1)) from the merchants 106.

In one implementation, the cardholders 104 is associated with the plurality of issuers 110. In one implementation, an issuer 110(1) is associated with a financial institution normally called an “issuer bank”, “issuing bank,” or simply “issuer”, in which a cardholder (e.g., the cardholder 104(1)) may have the payment account, (which also issues a payment card, such as a credit card or a debit card), and provides microfinance banking services (e.g., payment transaction using credit/debit cards) for processing electronic payment transactions, to the cardholder (e.g., the cardholder 104(1)).

In an implementation, the merchants 106 are associated with the plurality of acquirers 108. In an implementation, each merchant (e.g., the merchant 106(1)) is associated with an acquirer 108(1). In one implementation, the acquirer 108(1) is associated with a financial institution (e.g., a bank) that processes financial transactions for the merchant 106(1). This can be an institution that facilitates the processing of payment transactions for physical stores, merchants (e.g., the merchant 106(1)), or institutions that own platforms that make either online purchases or purchases made via software applications possible (e.g., shopping cart platform providers and in-app payment processing providers). The terms “acquirer”, “acquiring bank”, or “acquiring bank,” will be used interchangeably herein.

As described earlier, even though diffusion models excel at generating realistic and diverse synthetic data, they are prone to inheriting and even amplifying biases present in the training data. This can lead to unfair representation of sensitive attributes like race, gender, and age in the synthetic data that is generated. In addition to fairness concerns, class imbalance is another major challenge in training machine learning classifiers. A classifier trained on an imbalanced dataset can exhibit a bias toward the majority class, leading to poor generalization and unfair predictions. The synthetic data generated using diffusion models has emerged as a potential solution to mitigate this class imbalance by augmenting underrepresented classes. However, if the synthetic data itself contains inherent bias, then using such data to address the class imbalance may inadvertently reinforce the bias in the resulting balanced dataset. This counteracts the intended fairness and effectiveness of data balancing strategies and highlights the critical importance of ensuring that the synthetic data used for this purpose is unbiased.

To mitigate these concerns, various fairness-aware generative frameworks have been proposed. Traditional fairness approaches in machine learning fall under three categories such as pre-processing, in-processing, and post-processing. In the context of generative models, fairness is typically enforced via in-processing techniques, such as adjusting the training process or modifying the latent representations. For instance, some GAN-based techniques attempt to minimize the bias by adversarial removal of sensitive group indicators from the generated samples. More recent diffusion-based approaches, such as Fairness-Aware Augmentation for Domain Generalization via Classifier-Guided Score-Based Diffusion Models (FADE), attempt to enforce fairness by integrating auxiliary classifier guidance into the generative process. However, these methods often introduce additional computational complexity, require external models, or apply fairness constraints during the evaluation phase. These conventional methods fail to embed fairness naturally within the generative architecture and demonstrate suboptimal performance.

In parallel, mix-up-based methods have been explored to augment training data by interpolating between samples of different classes or sensitive groups. These strategies aim to smooth decision boundaries and reduce model sensitivity to group-based disparities. Although effective, they often address only limited aspects of fairness and may not fully generalize to the unique dynamics of diffusion-based generative modeling.

The above-described technical problem, among other problems, is addressed by one or more implementations implemented by the server system 102 of the present disclosure. In one implementation, the server system 102 is configured to perform one or more of the operations described herein.

In an implementation, the server system 102 may be coupled to the database 118. In one implementation, the database 118 may be incorporated in the server system 102, or may be an individual entity connected to the server system 102, or may be the database 118 stored in cloud storage. In various non-limiting examples, the database 118 may include one or more Hard Disk Drives (HDD), Solid-State Drives (SSD), an Advanced Technology Attachment (ATA) adapter, a Serial ATA (SATA) adapter, a Small Computer System Interface (SCSI) adapter, a redundant array of independent disks (RAID) controller, a Storage Area Network (SAN) adapter, a network adapter, and/or any component providing the server system 102 with access to the database 118. In one implementation, the database 118 may be viewed, accessed, amended, updated, and/or deleted by an administrator (not shown) associated with the server system 102 through a database management system (DBMS) or Relational DBMS (RDBMS) present within the database 118.

In an implementation, the database 118 may store the set of records 120, and the diffusion model 122. Herein, the term ‘records’ in some instances refers to each transaction record getting generated and stored in the database 118 as a result of the payment transactions that happen between the cardholders 104 and the merchants 106. In other instances, the term records can be used to refer to hospital medical records, Human resources records, lending records, public sectors records, etc., among any other tabular records, that may be biased. Herein, the diffusion model 122 indicates a Machine Learning (ML) model that is being trained using the set of records 120 to generate synthetic data that has minimal bias compared to the set of records 120.

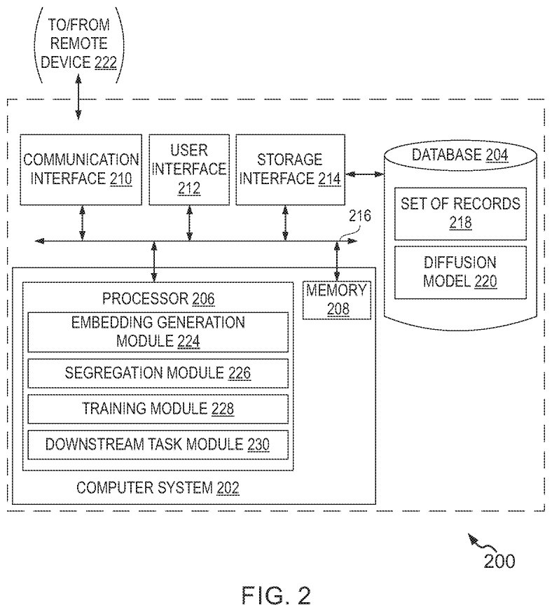

In a non-limiting implementation, the server system 102 is configured to access the set of records 120 from the database 118. Each record includes a set of first attributes and a set of second attributes. Herein, the term ‘first attributes’ indicates non-sensitive attributes such as a transaction identity (ID), education, transaction amount, and the like. Here, the term ‘sensitive attributes’ indicates sensitive attributes such as gender, race, age, religion, nationality, and so on. Further, the server system 102 is configured to generate a first embedding for each record based on the set of first attributes. Moreover, the server system 102 is configured to generate the second embedding for each record based on the set of second attributes. Herein, the term ‘embedding’ indicates the vector representation of attributes in a continuous, lower-dimensional space that captures the semantic meaning or relationships between them. The process of generating the first embedding and the second embedding has been described further in detail with reference to FIG. 2.

Further, the server system 102 is configured to compute a probability density of the set of second attributes associated with each record for the set of records based, at least in part, on the second embedding associated with each record. Herein, the term ‘probability density’ indicates how likely the set of second attributes associated with each record is to take on a particular value. Moreover, the server system 102 is configured to smoothen the second embedding associated with each record based, at least in part, on the probability density. This is to ensure minimal distinguishability between different second attributes associated with each record for the set of records. “Embedding smoothing” refers to any transformation, regularization, or optimization of sensitive-attribute embeddings that reduces group-wise distinguishability in the embedding or vector space, such that embeddings associated with different sensitive groups are represented in a smoother and more distributionally aligned manner prior to diffusion-model training. In some implementations, the smoothing is performed based on a probability density estimated from the sensitive-attribute embeddings. Smoothening can be implemented using a kernel-density-based objective, a mixing loss, or another loss that reduces abrupt density variation across sensitive groups. In an example, the second embedding associated with the first record and a second record can be [0.8, 0.2] and [0.1, 0.9], respectively. It may be observed that there exists a significant difference between the second embedding associated with the first record and the second record. After smoothening, the second embedding associated with the first record and the second record can be [0.45, 0.55] and [0.65, 0.35], respectively. It may be observed that the second embedding associated with the first record and the second record are indistinguishable after smoothening.

By eliminating the distinguishability between different second attributes, the direct bias present in the set of records 120 can be minimized. An exemplary process of smoothening the second embedding associated with each record has been described further in detail with reference to FIG. 2.

Further, the server system 102 is configured to generate a combined embedding for each record based, at least in part, on the corresponding first embedding and the corresponding second embedding. In particular, the server system 102 concatenates the first embedding and the second embedding corresponding to a particular record for generating the combined embedding for the said record. The collection of the combined embedding for the set of records 120 further acts as the input to the diffusion model 122.

Moreover, the server system 102 is configured to identify a plurality of second attribute types of the set of second attributes based, at least in part, on the set of records 120. Herein, the term ‘second attribute types’ indicates the types of the second attribute associated with a particular record. In an example, if the second attribute associated with the particular record is nationality, then the second attribute type can include Indian, Australian, British, and the like. In an example, if the second attribute associated with the particular record is gender, then the second attribute type can include male, female, transgender, and the like.

Further, the server system 102 is configured to segregate the set of records 120 into a plurality of distributed record sets based, at least in part, on the plurality of second attribute types. Herein, each distributed record set includes a subset of records associated with a subset of second attributes of a particular second attribute type. Here, each distributed record set has a corresponding distributed record set including a distinct subset of records associated with a distinct second attribute type.

In an example, the set of records 120 can have the plurality of second attribute types, such as a first gender and a second gender. In such a scenario, the server system 102 can segregate the set of records 120 into a first subset of records and a second subset of records. Here, the first subset of records can include records having the second attribute type as the first gender, and the second subset of records can include records having the second attribute type as the second gender.

Moreover, the server system 102 is configured to train the diffusion model 122 for a plurality of training epochs, based, at least in part, on performing a forward process and a reverse process. The training begins by initializing the diffusion model 122 with a set of model parameters. Herein, the term ‘model parameters’ indicates parameters that control how the diffusion model 122 learns from the training dataset. Herein, the term ‘training epoch’ indicates one complete pass through a training dataset (input) by the diffusion model 122. During each training epoch, the diffusion model 122 is configured to perform the forward process for each record. During this forward process, the diffusion model 122 is configured to obtain the combined embedding for the record. Then, the diffusion model 122 is configured to identify the distributed record set associated with the record. Upon identifying the distributed record set, the diffusion model 122 is configured to select the combined embedding for a randomly selected record from the corresponding distributed record set of the identified distributed record set. Returning to the previous example, the combined embedding obtained can belong to the distributed dataset in which each record is associated with the second attribute type as the first gender. In such a scenario, the combined embedding for the randomly selected record is chosen from the distributed dataset in which each record is associated with the second attribute type as the second gender.

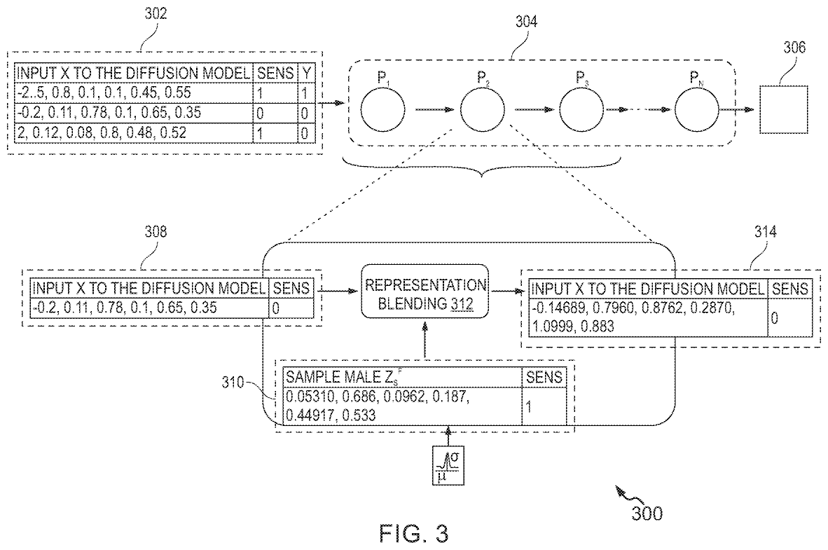

Additionally, the diffusion model 122 can generate a blended embedding for the record based, at least in part, on the combined embedding of the record and the combined embedding of the randomly selected record. In a non-limiting implementation, the combined embedding of the randomly selected record can be blended with the combined embedding of the record through a weighted summation process. Further, the diffusion model 122 is configured to generate a series of noisy embeddings based, at least in part, on progressively adding noise to the blended embedding for the record during an initial plurality of timesteps, and subsequently progressively adding noise to the combined embedding for the record for remaining timesteps. Herein, each noisy embedding in the series of noisy embeddings is associated with a particular timestep from the plurality of timesteps. In a non-limiting example, the blended embedding is generated up to a specific timestep ‘tₘᵢₓ’ (referred to interchangeably as a ‘predefined timestep’). Herein, the term ‘specific timestep’ indicates a particular timestep in the plurality of timesteps up to which the blended embedding is generated. In other words, the specific timestep identifies the initial plurality of timesteps. The decision of which specific timestep to select can be performed by an administrator (not shown) associated with the server system 102. This is done because the bias is generally visible up to the specific timestep ‘tₘᵢₓ’. This has been described further in detail with reference to FIG. 3. After this specific timestep, i.e., the remaining timesteps, only the combined embedding of the record (without blending with the combined embedding of the randomly selected record) is used to generate the series of noisy embeddings.

Further, the diffusion model 122 is configured to perform the reverse process for each record. During the reverse process, the diffusion model 122 is configured to generate a series of denoised embeddings based, at least in part, on progressively denoising each noisy embedding. Herein, each denoised embedding in the series of denoised embeddings corresponds to each noisy embedding. Each denoised embedding in the series of denoised embeddings corresponds to a previous timestep relative to a respective noisy embedding, such that the diffusion model 122 progressively maps an embedding at timestep t to a denoised embedding at timestep t−1. Here, the diffusion model 122 computes a predicted noise associated with each noisy embedding and uses the predicted noise to obtain the denoised embedding corresponding to a preceding timestep. Further, the diffusion model 122 is configured to compute a loss function. Herein, the ‘loss function’ indicates a mathematical function that computes an error for each denoised embedding based, at least in part, on the series of denoised embeddings and the series of noisy embeddings. Then, the server system 102 is configured to optimize the set of model parameters of the diffusion model 122 based, at least in part, on the error corresponding to each denoised embedding for each record.

In other words, the server system 102 is configured to smoothen the second embedding associated with each record. This will minimize the distinguishability between different second attributes associated with each record for the set of records, thereby eliminating direct bias present in the set of records 120. After smoothening, the second embedding is combined with the first embedding to generate the combined embedding. Further, during training, the diffusion model 122 is configured to generate the blended embedding. The blended embedding is formed utilizing the combined embedding of two different records that have distinct second attribute types. Such an intermixing helps to minimize any inherent bias present in the records. As a result, the diffusion model 122 trained using the combined embedding will have minimal bias and can be used to generate unbiased synthetic data. The trained diffusion model 122 can thereafter be used to generate synthetic data including a set of synthetic records having reduced bias. The synthetic data may be combined with the set of records 120 and used as training data for training a classification model to perform downstream classification tasks, such as fraud detection, credit-risk assessment, eligibility determination, anomaly detection, or other predictive classification operations. It is noted that the various aspects described with reference to FIG. 1 have been described further in detail with reference to FIG. 2 later on.

It is to be noted that the scope of this disclosure is not limited to the financial domain. Instead, it encompasses a wide range of applications across various industries, including but not limited to healthcare, e-commerce, and the like, facilitating broader implementation and adaptability in diverse contexts.

The number and arrangement of systems, devices, and/or networks shown in FIG. 1 are provided as an example. There may be additional systems, devices, and/or networks; fewer systems, devices, and/or networks; different systems, devices, and/or networks; and/or differently arranged systems, devices, and/or networks than those shown in FIG. 1. Furthermore, two or more systems or devices shown in FIG. 1 may be implemented within a single system or device, or a single system or device is shown in FIG. 1 may be implemented as multiple, distributed systems or devices. In addition, the server system 102 should be understood to be embodied in at least one computing device in communication with the network 116, which may be specifically configured, via executable instructions, to perform steps as described herein, and/or embodied in at least one non-transitory computer-readable media.

FIG. 2 illustrates a simplified block diagram of a server system 200, in accordance with an implementation of the present disclosure. The server system 200 is identical to the server system 102, described with reference to FIG. 1. In some implementations, the server system 200 is embodied as a cloud-based and/or software as a service (SaaS)-based architecture.

The server system 200 includes a computer system 202 and a database 204. The computer system 202 includes at least one processor 206 (herein, referred to interchangeably as ‘processor 206’) for executing instructions, a memory 208, a communication interface 210, a user interface 212, and a storage interface 214. One or more components of the computer system 202 communicate with each other via a bus 216. The components of the server system 200 provided herein may not be exhaustive, and the server system 200 may include more or fewer components than those depicted in FIG. 2. Further, two or more components depicted in FIG. 2 may be embodied in one single component, and/or one component may be configured using multiple sub-components to achieve the desired functionalities.

In some implementations, the database 204 is integrated into the computer system 202. In one non-limiting example, the database 204 is configured to store a set of records 218, and a diffusion model 220. Herein, the set of records 218 is identical to the set of records 120 described with reference to FIG. 1. Here, the diffusion model 220 is identical to the diffusion model 122 described with reference to FIG. 1.

In addition, the database 204 provides a storage location for data and/or metadata obtained from various operations performed by the server system 200. In one implementation, the database 204 is substantially similar to the database 118 of FIG. 1. Thus, it should be understood that all the details, data, or information as described in the description of FIG. 1 to be stored in the database 118 are applicable to the database 204 as well.

Further, the computer system 202 may include one or more hard disk drives as the database 204. The user interface 212 is an interface, such as a Human Machine Interface (HMI) or a software application that allows users, such as an administrator, to interact with and control the server system 200 or one or more parameters associated with the server system 200. It may be noted that the user interface 212 may be composed of several components that vary based on the complexity and purpose of the application. Examples of components of the user interface 212 may include visual elements, controls, navigation, feedback and alerts, user input and interaction, responsive design, user assistance and help, accessibility features, and the like. More specifically, these components may correspond to icons, layout, color schemes, buttons, sliders, dropdown menus, tabs, links, error/success messages, mouse and touch interactions, keyboard shortcuts, tooltips, screen readers, and the like.

The storage interface 214 is any component capable of providing the processor 206 access to the database 204. The storage interface 214 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 206 with access to the database 204.

The processor 206 includes suitable logic, circuitry, and/or interfaces to execute operations for training the diffusion model 220 utilizing the forward and reverse process. Examples of the processor 206 include, but are not limited to, an Application-Specific Integrated Circuit (ASIC) processor, a Reduced Instruction Set Computing (RISC) processor, a Graphical Processing Unit (GPU), a Complex Instruction Set Computing (CISC) processor, a Field-Programmable Gate Array (FPGA), and the like.

The memory 208 includes suitable logic, circuitry, and/or interfaces to store a set of computer-readable instructions for performing operations. Examples of the memory 208 include a Random-Access Memory (RAM), a Read-Only Memory (ROM), a removable storage drive, a Hard Disk Drive (HDD), and the like. It will be apparent to a person skilled in the art that the scope of the disclosure is not limited to realizing the memory 208 in the server system 200, as described herein. In another implementation, the memory 208 may be realized in the form of a database server or a cloud storage working in conjunction with the server system 200 without departing from the scope of the present disclosure.

The processor 206 is operatively coupled to the communication interface 210, such that the processor 206 is capable of communicating with a remote device 222, such as the plurality of issuers 110, the plurality of acquirers 108, the payment network 112, or communicating with any entity connected to the network 116 (as shown in FIG. 1).

It is noted that the server system 200, as illustrated and hereinafter described, is merely illustrative of an apparatus that could benefit from implementations of the present disclosure and, therefore, should not be taken to limit the scope of the present disclosure. It is noted that the server system 200 may include fewer or more components than those depicted in FIG. 2.

In one implementation, the processor 206 includes an embedding generation module 224, a segregation module 226, a training module 228, and a downstream task module 230. It should be noted that components described herein, such as the embedding generation module 224, the segregation module 226, the training module 228, and the downstream task module 230, can be configured in a variety of ways, including electronic circuitries, digital arithmetic, logic blocks, and memory systems in combination with software, firmware, and embedded technologies. Moreover, it may be noted that the embedding generation module 224, the segregation module 226, the training module 228, and the downstream task module 230 may be communicably coupled with each other to exchange information with each other for performing the one or more operations facilitated by the server system 200.

In an implementation, the embedding generation module 224 includes suitable logic and/or interfaces for receiving the set of records 218. Further, the embedding generation module 224 is configured to generate the first embedding for each record based, at least in part, on the set of first attributes. In particular, the embedding generation module 224 identifies one or more numerical attributes associated with each record. Then, the embedding generation module 224 is configured to normalize each of the numerical attributes using a quantile transformation technique. Further, the embedding generation module 224 utilizes a linear embedding layer to compute embeddings for each non-numerical attribute present in the set of attributes. This embedding layer can be associated with a neural network model and further be optimized based on the generated embeddings. An exemplary process of optimizing this embedding layer has been described further in detail with reference to FIG. 3. The embedding generation module 224 is configured to concatenate the normalized numerical attributes and the embeddings generated for each non-numerical attributes for a particular record to generate the first embedding for the said record.

Then, the embedding generation module 224 is configured to generate the second embedding for each record based, at least in part, on the set of second attributes. The embedding generation module 224 utilizes the linear embedding layer for generating the embeddings for each attribute present in the set of second attributes. Further, the embedding generation module 224 can be configured to compute the probability density of the second attributes associated with each record of the set of records 218. The probability density of the second attributes associated with each record of the set of records 218 can be computed based at least on the second embedding associated with each record. Furthermore, the embedding generation module 224 is configured to smoothen the second embedding associated with each record based, at least in part, on the probability density. In an implementation, the embedding generation module 224 utilizes the linear embedding layer for smoothening the second embedding associated with each record. This linear embedding layer can be further optimized based on a mixing loss computed based on the smoothened embeddings. An exemplary process of optimizing the linear embedding layer has been described further in detail with reference to FIG. 3. Moreover, the embedding generation module 224 is configured to generate the combined embedding based, at least in part, on the corresponding first embedding and the corresponding second embedding.

In an implementation, the segregation module 226 includes suitable logic and/or interfaces for identifying the plurality of second attribute types of the set of second attributes based on the set of records 218. The segregation module 226 is configured to segregate the set of records 218 into the plurality of distributed record sets based, at least in part, on the plurality of second attribute types. Herein, each distributed record set includes a subset of records associated with a subset of second attributes of a particular second attribute type. Here, each distributed record set has a corresponding distributed record set including a distinct subset of records associated with a distinct second attribute type.

In an example, the set of records 218 can have the plurality of second attribute types, such as a first race and a second race. In such a scenario, the server system 102 can segregate the set of records 218 into a first subset of records and a second subset of records. Here, the first subset of records can include records having the second attribute type as the first race, and the second subset of records can include records having the second attribute type as the second race.

In an implementation, the training module 228 includes suitable logic and/or interfaces for training the diffusion model 220 for a plurality of training epochs based on a forward process and a reverse process. At first, the diffusion model 220 is initialized based on a set of model parameters. During each training epoch, the diffusion model 220 is configured to perform the forward process for each record. The forward process can include obtaining the combined embedding for each record. Further, the diffusion model 220 is configured to identify the distributed record set associated with the record. Then, the diffusion model 220 is configured to select a combined embedding for a randomly selected record from the corresponding distributed record set of the identified distributed record set. Upon selecting the combined embedding for the randomly selected record, the diffusion model 220 is configured to generate the blended embedding for the record. The blended embedding for the record is generated based, at least in part, on the combined embedding of the record and the combined embedding of the randomly selected record. It is noted that blended embedding for the record is only computed till a predefined timestep, after which the diffusion model discontinues inter-group representation blending and applies a standard forward diffusion operation to the combined embedding of the record, including progressively adding Gaussian noise without incorporating a representation from another sensitive group.

In an example, the combined embedding obtained can belong to the distributed dataset in which each record is associated with the second attribute type as the first race. In such a scenario, the combined embedding for the randomly selected record is chosen from the distributed dataset in which each record is associated with the second attribute type as the second race.

Thereafter, the diffusion model 220 is configured to generate a series of noisy embeddings. Herein, the series of noisy embeddings are generated based, at least in part, on progressively adding noise to the blended embedding for the record during an initial plurality of timesteps, and subsequently progressively adding noise to the combined embedding for the record for remaining timesteps. Here, each noisy embedding in the series of noisy embeddings is associated with the particular timestep from the plurality of timesteps. An exemplary process of generating the series of noisy embeddings has been described further in detail with reference to FIG. 3.

The diffusion model 220 is configured to perform the reverse process for each record. Herein, the reverse process includes generating the series of denoised embeddings based, at least in part, on progressively denoising each noisy embedding. Herein, each denoised embedding in the series of denoised embeddings corresponds to a previous timestep relative to a respective noisy embedding, such that the diffusion model 220 progressively maps an embedding at timestep t to a denoised embedding at timestep t−1. Here, the diffusion model 220 computes a predicted noise associated with each noisy embedding and uses the predicted noise to obtain the denoised embedding corresponding to a preceding timestep. Further, the diffusion model 220 is configured to compute the loss function, which gives an error for each denoised embedding based, at least in part, on the series of denoised embeddings and the series of noisy embeddings. The diffusion model 220 compares the predicted noise with actual noise added to generate the noisy embedding, and the loss function computes the error based on the comparison between the predicted noise and the actual noise. This aspect is explained later with reference to FIG. 3. Furthermore, the training module 228 is configured to optimize the set of model parameters of the diffusion model 220 based, at least in part, on the error corresponding to each denoised embedding for each record. This training process is repeated for the plurality of epochs to obtain a trained diffusion model 220.

In an implementation, the downstream task module 230 includes suitable logic and/or interfaces for generating a set of synthetic records. In particular, for generating the set of synthetic records, the downstream task module 230 is configured to obtain a noise distribution from the database 204. Herein, the noise distribution can include a set of noise vectors. In an example, the noise distribution is a Gaussian noise distribution. Further, the downstream task module 230 is configured to perform the reverse process via the trained diffusion model 220 on the noise distribution to obtain the set of synthetic records. Once the set of synthetic records is generated, it can be combined with the set of records 218 and used as training data for training a classification model to perform downstream classification tasks. Examples of such classification tasks include, but are not limited to, fraud detection, credit-risk assessment, eligibility determination, anomaly detection, disease classification, or other predictive classification operations.

In an example, the diffusion model 220 can be trained to generate patient records. In such a scenario, the downstream task module 230 obtains the noise distribution from the database 204 and feeds it to the trained diffusion model 220. The diffusion model 220, in turn, generates the synthetic patient records based on the noise distribution.

In an example, the generated patient records can include records such as Patient A: 45-year-old female, diagnosed with Type 2 diabetes, prescribed Metformin, recent HbAlc=7.8%. In another example, the generated synthetic patient records can include records such as Patient B: a 60-year-old male, with a history of hypertension and elevated LDL cholesterol, on statin therapy.

In short, the server system 200 is configured to perform a smoothing operation on the second embedding associated with each record. This smoothing effectively minimizes the distinguishability between different second attributes associated with each record. By doing so, the process neutralizes direct bias that may otherwise propagate through the training pipeline. After smoothing, the second embedding is combined with the first embedding (representing non-sensitive features) to form a unified or combined embedding for each record. This combined embedding captures both protected and non-protected feature representations.

During training, the diffusion model 220 utilizes these combined embeddings to generate blended embeddings till a predefined timestep, i.e., an initial plurality of timesteps by intermixing embeddings from records that belong to distinct groups based on the second attribute. This inter-group blending addresses indirect bias by ensuring the latent space is influenced by multiple sensitive groups, rather than favouring one group. The diffusion model 220 trained on the blended embedding till the predefined timestep along with the combined embeddings for the remaining timesteps, is capable of generating synthetic data that is fairly unbiased. The proposed approach enhances fairness by embedding it directly into the training process, removes the need for auxiliary debiasing models, preserves data utility, and is highly applicable in sensitive domains like healthcare, finance, and criminal justice, where ethical data generation is paramount.

FIG. 3 illustrates a schematic representation of an architecture 300 of a diffusion model such as the diffusion model 220, in accordance with an implementation of the present disclosure. For training the diffusion model 220 to generate the synthetic data, a training dataset is used. In a non-limiting example, the training dataset may be represented using the following exemplary equation:

D=(X,Z,Y) Eqn. (1)

Herein ‘D’ indicates the training dataset, ‘X’ indicates a feature space which includes both numerical features ‘Xₙᵤₘ’ and categorical features ‘X_{cat}’. Here, the numerical features and the categorical features can be considered as the first set of attributes. Herein, the term ‘numerical feature’ indicates a type of data that represents a number. Here, the term ‘categorical feature’ indicates a type of data that represents categories. Here ‘Z’ indicates sensitive attributes (i.e., a second set of attributes), where ‘Z∈{0,S}’ denotes the protected groups. Herein, ‘Y’ indicates a target variable. The main objective of the training process is to train the diffusion model 220 that generates the synthetic data that is fair. This ensures unbiased positive predictions when a classifier is trained on the synthetic data, regardless of the protected groups. Additionally, the synthetic data should accurately represent the actual data distribution.

This training process can include two major steps, such as embedding smoothening and representation blending in the forward process. In the embedding smoothening step, the linear embedding layer is utilized. This linear embedding layer can transform categorical attributes (i.e., non-sensitive attributes), and the sensitive attributes present in the training dataset into a numerical representation. This eliminates the need for an additional multinomial diffusion model. The linear embedding layer is specifically engineered to learn rich semantic representations of the sensitive attributes, effectively neutralizing direct sensitive information and preserving the relational structure of categorical attributes with the class label in the embedding space. The transformed embeddings are concatenated with numerical attributes and subsequently fed into the diffusion model 220. In a non-limiting example, the diffusion model 220 can be a Gaussian diffusion model. The primary objective of employing a dedicated embedding layer for the sensitive attributes is to merge the probability density of different sensitive groups within the embedding space, ensuring minimal distinguishability between them before being processed by the diffusion model 220.

The liner embedding layer is trained by first estimating a Gaussian kernel density (i.e., probability density) using pairwise Euclidean distances for each sensitive group. Herein, a sensitive group can include a set of records such as the set of records 218 having the same second attribute type. Then, a loss function inspired from kernel density smoothing is minimized to facilitate a more continuous and unbiased representation of sensitive attributes (i.e., a set of second attributes) in the embedding space. It is understood that a large gradient in the kernel density smoothing indicates rapid variations in density across different groups, resulting in distributional disparities. By minimizing a Kernel Density Estimation (KDE) gradient, abrupt changes in the probability density are mitigated, leading to a smoother and more uniform probability distribution across sensitive groups. This ensures that direct bias is not propagated through the forward and reverse processes of the diffusion model 220, thereby promoting fairness in the generated data (i.e., synthetic data). In a non-limiting example, the KDE gradient may be computed using the following exemplary equation:

$${S}_{s} = exp ( - \frac{{D}_{s}^{2}}{2 {τ}^{2}} ) , {D}_{s} = {‖ {E}_{s} - {E}_{s}^{T} ‖}_{2} \qquad Eqn . ( 2 )$$

Herein, ‘Sₛ’ indicates similarity between embeddings belonging to the same sensitive groups. Here, ‘Dₛ’ indicates pairwise squared Euclidean distances between embeddings of samples belonging to the same sensitive group. Here, ‘T’ indicates a temperature parameter that controls the bandwidth of the Gaussian kernel. Herein, ‘Eₛ’ indicates sensitive embedding associated with a particular sensitive group, where ‘s∈{0, S}’. Further, the mixing loss is computed based on which the model parameters of the linear embedding layer can be fine-tuned. In a non-limiting example, the mixing loss may be computed using the following exemplary equation:

$${L}_{mixing} = δ ( {\sum }_{s = 1}^{S} {S}_{s} ) = min {\sum }_{s = 1}^{S} exp ( - \frac{{D}_{s}^{2}}{2 {τ}^{2}} ) \cdot ( - \frac{1}{{τ}^{2}} ( {E}_{s} - {E}_{s}^{T} ) ) \qquad Eqn . ( 3 )$$

Herein, the ‘S’ indicates the number of sensitive groups, and ‘8’ indicates the objective of minimizing the mixing loss. In an exemplary scenario, for categorical features ‘X_{cat}’, the categorical embedding is trained by applying a softplus activation layer to obtain logits. This is followed by minimizing the Binary Cross Entropy (BCE) loss between the logits and the class labels. This additional loss function is introduced for the categorical layer to enhance generalization, rather than optimizing it end-to-end along with the rest of the diffusion model during backpropagation. In a non-limiting example, the logits may be computed using the following exemplary equation:

logits=Σ_{d} ln(1+e^{E}^{_{cat,d}}) Eqn. (4)

Herein, ‘E_{cat,d}’ embedding vector component for the d^{th} dimension of a categorical feature embedding and ‘Σ_{d}’ indicates summation over all embedding dimensions. In a non-limiting example, the categorical loss may be computed using the following exemplary equation:

L_{y}=BCE(logits,y) Eqn. (5)

Here, ‘L_{y}’ indicates the categorical loss, ‘y’ indicates a true class label. The categorical loss and the mixing loss are minimized during the training process of the diffusion model 220, and a new rich representation is fed into the diffusion model 220 at each epoch. This advanced embedding layer architecture not only transforms object-type datasets into a rich representation but also neutralizes direct bias present in the training dataset while maintaining accuracy. Both categorical embedding (i.e., first embedding) and sensitive embedding (i.e., second embedding) are stacked with the numerical data and then fed into the diffusion model 220. In this way, the direct bias in the training dataset can be proactively handled, preventing the diffusion model 220 from learning differentiation between sensitive groups.

The embedding smoothing can mitigate the direct bias present in the training dataset, but it cannot address indirect bias in other features. For addressing the indirect bias, representational blending can be used. The representation blending is a type of mixing technique in which a sample from one sensitive group is combined with the latent space of another sensitive group for a given sensitive attribute till the specific or predefined timestep ‘Tₘᵢₓ’. Merging a fresh sample from one sensitive group with the latent features of another not only mitigates the indirect bias but also improves the generalization capacity of the diffusion model 220 by increasing complexity in the latent space. It is to be noted that a constant inherent bias present in the training dataset gets propagated throughout the entire forward diffusion process and gets reconstructed during the reverse diffusion process. This preserves biased distributions in generated samples. To prove this notion, the bias has to be quantified. In a non-limiting example, the bias may be represented using the following exemplary equation:

μₛ≠μ_{s′}μₛ=E[X₀|S=s],μ_{s′}=E[X₀|S=s′] Eqn. (6)

Herein, ‘X₀’ indicates the original input sample, ‘S’ indicates the sensitive attribute, ‘μ_{s′}’ indicates the mean of the original input sample for the sensitive group ‘s’. Here, ‘μ_{s′} ’ indicates the mean of the original input sample for the sensitive group ‘s′’. Further, by taking expectations on both sides of the equation representing the forward diffusion process of the diffusion model 220, it can be shown that the expected value of the diffused data ‘Xₜ’ for a given group ‘S=s’ is just a scaled version of the original group-wise mean. In a non-limiting example, the expected value may be computed using the following exemplary equation:

E[Xₜ|S=s]=āₜE[X₀|S=s] Eqn. (7)

Herein, ‘āₜ’ indicates a scalar coefficient specific to time step ‘t’, representing how much signal from the original data ‘X₀’ is retained at step ‘t’ during the forward diffusion process. Further, group-wise bias differences can be computed since expectations remain proportional across diffusion steps. In a non-limiting example, the group-wise bias differences may be computed using the following exemplary equation:

E[Xₜ|S=s]−E[Xₜ|S=s′]=āₜ(μₛ−μ_{s′}) Eqn. (8)

The difference between distributions can be further computed using Wasserstein-2 distance. In a non-limiting example, the Wasserstein-2 distance may be computed using the following exemplary equation:

W₂(q(Xₜ|S=s),q(Xₜ|S=s′))=āₜW₂(q(X₀|S=s),q(X₀|S=s′)) Eqn. (9)

Here, it can be seen that the bias is linearly scaled by ‘āₜ’ in all intermediate ‘Xₜ’ but never eliminated, but since noise variance increases as time progresses, the bias is only visible till the specific timestep ‘tₘᵢₓ’. This is the reason behind restricting the mixing of samples from one sensitive group with the latent space of another sensitive group for generating the blended embedding till ‘tₘᵢₓ’, i.e., the initial plurality of timesteps. Since the diffusion model 220 is trained on the training dataset that is biased, the learned probabilistic distribution ‘p_{θ}(x₀)’ reflects the same statistical biases present, leading to biased sample generation. The reverse process approximates the true posterior ‘q(xₜ₋₁|xₜ)’ using a learned denoising function ‘P_{θ}(xₜ₋₁|xₜ):=N(μ₀(xₜ,t), \tilde{β}ₜI)’, where ‘μ₀(xₜ, t)’ is a learned function trained on biased data, which is ‘N(θ(x₁, 1), \tilde{β}₁l)’. In a non-limiting implementation, the generated samples will exhibit the same Wasserstein distance between groups, proving that bias is retained. In a non-limiting example, this may be represented using the following exemplary equation:

\hat{μ}_{θ}(Xₜ|S=s)−\hat{μ}_{θ}(Xₜ|S=s′)≈E[X₀|S=s]−E[X₀|S=s′] Eqn. (10)

Here, ‘Xₜ’ indicates a noisy version of ‘X₀’. Here, ‘\hat{μ}_{θ}(Xₜ|S=s)’ indicates diffusion model's estimate of the original data ‘X₀’ given a noisy sample ‘Xₜ’ and the group as ‘S=s’. Here, ‘\hat{μ}_{θ}(Xₜ|S=s′)’ indicates the diffusion model's 220 estimate of the original data ‘X₀’ given a noisy sample ‘Xₜ’ and the group as ‘S=s′’. Here, ‘E[X₀|]’ indicates the true group-wise mean. To mitigate the inherent bias in the forward diffusion process, a fixed correction term can be integrated into the forward process. This adjustment counteracts the latent-space bias, ensuring a more neutral representation. Since the bias manifests as a distributional shift in the expectation across different sensitive groups, the forward process must incorporate a bias-corrected term that counteracts this shift, preventing the reverse process from perpetuating bias. This fixed correction term can be used to modify the forward diffusion equation by modifying the mean. In a non-limiting example, the modified forward diffusion equation may be represented using the following exemplary equation:

q(xₜ|xₜ₋₁):=N(xₜ; \sqrt{1−βₜ}(λxₜ₋₁+(1−λ)δ_{b}),βₜl),λ~N(0.5,1) Eqn. (11)

Herein, ‘q(Xₜ|xₜ₋₁)’ indicates the posterior distribution for the forward process, ‘xₜ₋₁’ indicates representation at a previous time step, ‘δ_{b}’ indicates a blended sample from a different sensitive group. Here, ‘λ~N(0.5, 1)’ indicates a random blending coefficient. Herein, ‘λxₜ₋₁+(1−λ)δ_{b}’ indicates a blended representation, ‘\sqrt{1−βₜ}’ indicates a scaling factor, ‘βₜ’ indicates the variance of noise added at a time ‘t’. This modified forward diffusion equation is used only for computing the noisy form of the input up to a specific or predefined timestep i.e., ‘tₘᵢₓ’. The ‘δ_{b}’ can be approximated by drawing samples from the conditional distribution. In a non-limiting example, the conditional distribution may be represented using the following exemplary equation:

P(X|S=s)=E[X^{t}|S=s] Eqn. (12)

For a given sample ‘S=s′’, the Eqn. (11) may be represented as the following exemplary equation:

x_{t,s}=\sqrt{1−βₜ}(λx_{t-1,s}+(1−λ)δ_{b,s′})+\sqrt{β}ₜuₜ₋₁ Eqn. (13)

More specifically, to a given sample from the sensitive group ‘s’, the blended representation ‘δ_{b}’ from different sensitive groups is added till the specific timestep of the forward process. This ensures a correction term in the mean shift across different sensitive groups, thereby guiding the reverse process parameters ‘μ_{θ}(xₜ, t)’ to be learned on a bias-corrected forward posterior. Consequently, the generated data exhibits fairness with an approximated reverse process distribution ‘E[X_{0, gen}|S=s]≈E[X_{0, gen}|S=s]’.

After ‘tₘᵢₓ’, the diffusion model 220 utilizes the standard forward diffusion equation for computing the noisy form of the input. In a non-limiting example, the standard forward diffusion equation may be represented using the following exemplary equation.

$$q ( {x}_{1 : T} \vert {x}_{0} ) := {\prod }_{t = 1}^{T} q ( {x}_{t} \vert {x}_{t - 1} ) , \qquad Eqn . ( 14 )$$

$$q ( {x}_{t} \vert {x}_{t - 1} ) := 𝒩 ( {x}_{{t}^{;}} \sqrt{1 - {β}_{t}} {x}_{t - 1} , {β}_{t} I ) ,$$

$$q ( {x}_{T} ) := 𝒩 ( {x}_{T} ; 0 , I )$$

Herein, ‘q(x_{T}):=N(x_{T}; 0, I)’ indicates the end state of the forward process, ‘q(x_{1:T}|x₀)’ indicates joint probability distribution. Here, ‘q(xₜ|xₜ₋₁), q(xₜ|xₜ₋₁)’ indicates conditional probability distribution,

$$‘ {\prod }_{t - 1}^{T} q ( {x}_{t} \vert {x}_{t - 1} ) ’$$

indicates the forward process of a Markov chain.

In a non-limiting example, an exemplary pseudo-code for the proposed approach is given below:

Input:

Training dataset with numerical features, categorical features, sensitive attributes,
and a target variable.
A number of diffusion steps.
A timestep for blending.
A schedule for noise variance.

Output:

Fair synthetic dataset.

Steps:

| | |
|---|---|
| 1. | Embedding Smoothing: |

For each sensitive attribute in the dataset:

Calculate a sensitive embedding using kernel density smoothing.
Optimize the embedding to reduce direct bias.

Combine the smoothed sensitive embeddings with the numerical features and
categorical embeddings.

| | |
|---|---|
| 2. | Forward Diffusion Process with Representation Blending: |

For each training sample in the dataset:

For each diffusion timestep:

If the current timestep is less than or equal to the specific or
predefined timestep, i.e., the initial plurality of timesteps:

Select a sample from a different sensitive group.
Blend the current sample's representation with the
representation from the other sensitive group.
Add noise to the blended representation.

Else perform for the remaining timesteps:

Add standard Gaussian noise to the current sample.

Reverse Diffusion Process:

For each generated sample, starting from pure noise:

For each reverse diffusion timestep (going backward in time):

Calculate the predicted mean.
Perform the reverse diffusion process to remove noise and get
the previous step's data.

Output the final generated data as the fair synthetic dataset

The working of the proposed approach can be described using an exemplary transaction dataset. The transaction dataset includes a set of transaction records. Each record is associated with, a transaction identity (ID), the set of first attributes such as amount, and education of the cardholder 104(1), the set of second attributes indicative of gender. In a non-limiting example, the exemplary transaction dataset is provided in Table 1, given below:

TABLE 1
Exemplary transaction dataset.

| Transaction (ID) | Amount | Education | Gender S | Fraud label y |
|---|---|---|---|---|
| 1 | 2 | Bachelor | Male | 1 |
| 2 | 5 | Master | Female | 0 |
| 3 | 10 | PhD | Male | 0 |

It is noted that Table 1 to Table 6 depict various results received from the various experiments described herein. It is noted that if the various results are reproduced, it may be associated with an approximate error of +/−5%.

Further, the amount associated with each transaction ID undergoes a quantile transformation, and the educational attributes and the gender attributes associated with each record are converted into corresponding embeddings. In a non-limiting example, the transaction dataset obtained after performing the quantile transformation and the embedding generation is provided in Table 2, given below:

TABLE 2
The transaction dataset obtained after performing the
quantile transformation and the embedding generation.

| Amount | Education | Gender S | Fraud label y |
|---|---|---|---|
| −2.5 | [0.8, 0.1, 0.1] | [0.8, 0.2] | 1 |
| −0.2 | [0.11, 0.78, 0.1] | [0.1, 0.9] | 0 |
| 2 | [0.12, 0.08, 0.8] | [0.9, 0.1] | 0 |

Herein, the combination of the embedding associated with the education and the quantile transformed amount associated with each record can be referred to as the first embedding. Moreover, it can be seen that there is a significant deviation between embeddings of gender attributes. To make these embeddings indistinguishable from each other, the embedding smoothening is performed for each embedding representing the gender attribute. In a non-limiting example, the transaction dataset obtained after performing the embedding smoothening on the embeddings representing the gender attribute is provided in Table 3, given below:

TABLE 3
The transaction dataset obtained after embedding smoothening.

| Amount | Education | Gender | Fraud label y |
|---|---|---|---|
| −2.5 | [0.8, 0.1, 0.1] | [0.45, 0.55] | 1 |
| −0.2 | [0.11, 0.78, 0.1] | [0.65, 0.35] | 0 |
| 2 | [0.12, 0.08, 0.8] | [0.48, 0.52] | 0 |

The gender attribute associated with each record after the embedding smoothening can be referred to as the second embedding. Additionally, the combined embedding for each record can be generated by concatenating the first embedding and the second embedding associated with the said record. In a non-limiting example, the combined embedding generated for each record is provided in Table 4, given below:

TABLE 4
The combined embedding for each record.

| Combined embedding | S | y |
|---|---|---|
| −2.5, 0.8, 0.1, 0.1, 0.45, 0.55 | 1 | 1 |
| −0.2, 0.11, 0.78, 0.1, 0.65, 0.35 | 0 | 0 |
| 2, 0.12, 0.08, 0.8, 0.48, 0.52 | 1 | 0 |

Herein, ‘S’ indicates the attribute label or the second attribute type, and ‘y’ indicates the fraud label. A combined embedding 302 is provided to the diffusion model 220 as the input. Then the combined embedding (see, 308) corresponding to a particular record is randomly selected. The gender attribute associated with the selected combined embedding (see, 308) is determined based on the corresponding attribute label. Then, another combined embedding (see, 310) associated with a different attribute label is selected and combined with the previously selected combined embedding (see, 308) to generate the blended embedding (see, 314). The process of combining another combined embedding (see, 310) with the previously selected combined embedding (see, 308) is represented as representational blending 312. The series of noisy embeddings are computed from this blended embedding (see, 314) utilizing the Eqn. (13) till the initial plurality of timesteps. The computation of the series of noisy embeddings can happen for predefined timesteps (see, 304). After that, i.e., for the remaining timesteps, the input gets transformed into pure noise 306 based on the combined embeddings. During the reverse diffusion process, the series of denoised embeddings are generated by progressively denoising each noisy embedding, and the loss function is computed. Here, the diffusion model 220 computes a predicted noise associated with each noisy embedding and uses the predicted noise to obtain the denoised embedding corresponding to a preceding timestep. In a non-limiting example, the series of denoised embeddings may be computed using the following exemplary equation.

$${p}_{θ} ( {x}_{0 : T} ) := p ( {x}_{T} ) {\prod }_{t = 1}^{T} {p}_{θ} ( {x}_{t - 1} \vert {x}_{t} ) , \qquad Eqn . ( 15 )$$

$${p}_{θ} ( {x}_{t - 1} \vert {x}_{t} ) := 𝒩 ( {x}_{t - 1} ; {μ}_{θ} ( {x}_{t} , t ) , {\sum }_{θ} ( {x}_{t} , t ) )$$

Herein, ‘x_{0:T}’ indicates the sequence of variables where ‘xₜ’ indicates noisy sample and ‘x₀’ indicates original data. Here, ‘p_{θ}(x_{0:T})’ indicates the joint distribution of the diffusion model 220, ‘p(x_{T})’ prior distribution at the end of the forward diffusion process,

$$‘ {\prod }_{t = 1}^{T} {p}_{θ} ( {x}_{t - 1} \vert {x}_{t} ) ’$$

indicates the reverse process. Here, ‘p_{θ}(xₜ₋₁|xₜ)’ indicates the denoising distribution and ‘N(xₜ₋₁; μ_{θ}(xₜ, t), Σ_{θ}(xₜ, t)’ indicates that the process is Gaussian. In a non-limiting example, the loss function may be computed using the following exemplary equation:

$${L}_{simple}^{t} = {E}_{{x}_{0} , ϵ , t} {‖ ϵ - {ϵ}_{θ} ( {x}_{t} , t ) ‖}_{2}^{2} \qquad Eqn . ( 16 )$$

Here,

$$‘ {L}_{simple}^{t} ’$$

indicates the loss, ‘∈’ indicates actual noise, ‘∈_{θ}(xₜ, t)’ indicates the estimated noise. The loss function for gaussian diffusion process is minimization of mean-squared-error between actual added noise and the estimated noise.

For evaluating the performance of the proposed approach, the said approach is assessed against various tabular generative models in terms of fairness and generalization across two datasets. These datasets can include an adult dataset and a bank marketing dataset. The adult dataset serves as a benchmark for fairness evaluation. It includes 8 categorical features, 5 numerical features, and a binary target label representing annual income. This dataset contains approximately 48,842 instances, with an approximate positive class event rate of 24. If gender is considered as the sensitive attribute, its distribution in the positive class is skewed, with an approximate event rate of 15% for the unprivileged group. This data set does not contain missing values, however, attributes such as class, occupation, and native country include instances labeled as “?”. These values have been replaced with the mode of their respective columns. The bank marketing dataset is a multivariate dataset containing approximately 45,211 non-null rows and approximately 18 columns, including approximately 7 numerical features, and approximately 9 categorical features. It includes a binary class label indicating whether a client has subscribed to a term deposit. The dataset exhibits a class imbalance ratio of approximately 11.7%, with marital status considered as the sensitive attribute.

The experiments are conducted by generating synthetic samples using the proposed approach and then training an Extreme Gradient (XG) boost classifier on a synthetic dataset, including the synthetic samples. The synthetic dataset is further divided into a training set and a test set including 80% of synthetic samples and 20% of synthetic samples, respectively, while maintaining the positive class event rate. The proposed approach has been developed on the training set and the performance of the XGboost classifier has been evaluated using the test set. In a non-limiting implementation, the proposed approach is implemented using a pytorch framework. Numerical features are normalized using quantile transformation, and categorical features are transformed using label encoding. Two different embedding layers are used for the categorical attributes and the sensitive attributes for both the datasets to convert each token into a 2-dimensional numerical embedding. The weight matrices ‘E_{c}’ for the categorical embedding layer and ‘Eₛ’ for the sensitive embedding layer are updated within the same training pipeline of the diffusion model by minimizing Loss1 and Loss2. The corresponding weights ‘w1’ and ‘w2’ are set to 0.4 and 0.6 for the adult dataset and 0.5 and 1 for the bank marketing dataset. These values have been optimized through model parameter tuning within the range of [0,1] for both losses for maximum accuracy and minimum demographic parity. In a non-limiting implementation, the training diffusion step can be fixed as 500, followed by linearly scheduling noise variance increasing from 1e⁻⁴ to 0.02. Generation diffusion steps are 150 for the adult dataset and 200 for the bank marketing dataset.

Herein, the diffusion model architecture is a 3-layer feed-forward neural network with leaky Rectified Linear Unit (ReLU) activation and 256 neurons in each layer. The diffusion model 220 has been trained for 300 epochs for both datasets. The training implementation utilizes the Adam optimizer with a learning rate of 1e⁻⁴ to update the neural network's weights. Finally, synthetic data are generated using the proposed approach, equivalent to the number of training samples while maintaining the class imbalance ratio. The XGBoost model parameters are set with 400 boosting rounds, 0.05 learning rate, and depth as 4 for both datasets and are fixed for all the trained XGBoost models. The model was trained by monitoring Area Under the Precision-Recall Curve (AUCPR) on the validation set (10% of the training set), and a default threshold of 0.5 was used for the predictions.

The classification performance of the XGboost classifier is evaluated using accuracy and fairness. The generated data is evaluated using generalization metrics including accuracy, fidelity, and privacy, and fairness metrics including DP, EO, EOp, SP, D-fair, and auxiliary prediction correlation The accuracy is used to evaluate the effectiveness of the XGboost classifier by measuring the proportion of correctly classified instances out of all instances in the dataset. The accuracy can be used to assess the generalization of the synthetic data when it is used to train the XGboost classifier and generate a prediction on unseen test data. The fidelity measures how well the synthetic data represents the actual population captured by the real data. The column-wise similarity is assessed using the Kolmogorov-Smirnov (KS) statistic, while pairwise row similarity is measured using Pearson correlation. For categorical features, Total Variation (TV) distance is used in both cases. Finally, the average of row-wise and column-wise similarity scores is computed for the overall evaluation. The privacy metric quantifies the extent to which the synthetic data prevents the identification of original data entries. This metric is particularly relevant in safeguarding the real data by preventing the disclosure of the same. To evaluate the privacy of the generated data, a Distance to Closest Records (DCR) metric can be computed. In a non-limiting example, the DCR metric may be computed using the following exemplary equation:

$$D C R ( {s}_{n} ) = {min}_{x ∈ X} d ( {s}_{n} , x ) \qquad Eqn . ( 17 )$$

Further Demographic Parity (DP) difference metric is computed for the XGboost classifier. Herein, the DP Difference metric indicates a difference in the proportion of positive predicted outcomes across different demographic groups. It ensures that the XGboost classifier produces unbiased positive predictions, thereby ensuring that the XGboost classifier is trained on a fair dataset. In a non-limiting example, the DP difference metric may be computed using the following exemplary equation:

ΔDP=P(Ŷ=1|Z=0)−P(Ŷ=1|Z=1) Eqn. (18)

For evaluating whether the XGboost classifier performs similarly across different sensitive groups, an Equalized Odd (EO) difference metric can be computed. The EO difference metric is computed based on both the true positive rate and the false positive rate for all demographic groups. In a non-limiting example, the EO difference metric may be computed using the following exemplary equation:

ΔEO=(P(Ŷ=1|Z=0,Y=y)+P(Ý=1|Z=1,Y=y)) Eqn. (19)

Further, Equalized Opportunity (EOp) difference metric, can be used to evaluate whether the XGboost classifier performs similarly across all demographic groups. The EO difference focuses only on true positive rates. In a non-limiting example, the EO difference metric may be computed using the following exemplary equation:

ΔEOp=P(Ŷ=1|Z=0,Y=1)−P(Ŷ=1|Z=1,Y=1) Eqn. (20)

A Statistical Parity (SP) metric can be computed to evaluate the difference in the proportion of positive classes across different demographic groups in the dataset. The SP metric indicates a disparity in the actual data distribution for the positive class. In a non-limiting example, the SP metric may be computed using the following exemplary equation:

ΔDP=P(Y=1|Z=0)−P(Y=1|Z=1) Eqn. (21)

Further, a D-Fair metric may be computed. It quantifies dataset fairness by computing the disparity between the distances from the mean of the generated dataset to the mean points of two distinct sensitive groups in the original dataset. In a non-limiting example, the D-fair metric may be computed using the following exemplary equation:

D_{fair}=∥μ(D_{gen})−μ(D_{actual,z=0})∥₂−∥μ(D_{gen})−μ(D_{actual,Z=1})∥₂ Eqn. (22)

For ensuring fairness, one of the criteria is there should be no correlation between sensitive attributes and class labels. For evaluating this, two linear classifiers such as, ‘Cₛₑₙₛ’ and ‘C_{cls}’, that predict sensitive attributes and class labels from the generated features are used. Then the cosine similarity between their weight matrices is computed for evaluating the correlation.

The effectiveness of the proposed approach is evaluated by generating the synthetic dataset and training the XGBoost classifier on the generated synthetic dataset. The synthetic dataset is generated while maintaining the positive class event rate as the same as that of the actual dataset. The fairness metrics and the accuracy metrics are then measured and compared with the performance of three traditional generative models such as a Variational Auto Encoder (VAE), a Generative Adversarial Network (GAN), and a Denoising Diffusion Probabilistic Model (DDPM). The fairness metrics and the accuracy metrics are compared with five fair generative models such as Fair Generative Adversarial Network (FGAN), Generating Fair Synthetic Data Using Causally Aware Generative Networks (DECAF), Fair Disentangled Conditional (FDisCo), and Fairness-Aware Augmentation for Domain Generalization via Classifier-Guided Score-Based Diffusion Models (FADE).

The performance of the generative models can be evaluated based on the accuracy and fairness performance of the XGBoost classifier trained on a synthetic dataset generated by the said generative models. In a non-limiting example, percentages of accuracy and fairness achieved by various generative models are provided in Table 5 given below:

TABLE 5
Accuracy and fairness achieved by different generative models

| | Adult Dataset | | | | Banking Dataset | | | |
|---|---|---|---|---|---|---|---|---|
| | Accuracy | DP | EO | EOp | Accuracy | DP | EO | EOp |
| VAE | 83.27 | 0.21 | 0.26 | 0.38 | 82.88 | 0.08 | 0.12 | 0.19 |
| GAN | 76.42 | 0.17 | 0.26 | 0.29 | 78.48 | 0.08 | 0.12 | 0.22 |
| DDPM | 84.29 | 0.17 | 0.23 | 0.37 | 82.65 | 0.06 | 0.12 | 0.20 |
| FGAN | 78.99 | 0.09 | 0.13 | 0.20 | 78.20 | 0.05 | 0.07 | 0.13 |
| FADE | 84.55 | 0.09 | 0.12 | 0.19 | 80.84 | 0.03 | 0.06 | 0.11 |
| Proposed | 80.57 | 0.07 | 0.03 | 0.06 | 87.83 | 0.01 | 0.009 | 0.006 |
| approach | | | | | | | | |

Considering the adult dataset, DDPM performs best compared to all classical generative models in terms of both accuracy and fairness, demonstrating its superiority over VAE/GAN. FADE is the highest-performing baseline in terms of both fairness and accuracy. The proposed approach achieves the best fairness metrics, with a 22% reduction in DP, a 75% reduction in EO, and a 68% reduction in EOp, although its accuracy does not surpass that of FADE.

For the bank marketing dataset, it may be observed that VAE and DDPM have comparable results. FADE's accuracy dropped compared to classical generative models, but it improved the fairness of synthetic data more than all the baseline methods. The proposed approach achieves the highest performance in both accuracy and fairness compared to all other generative models. It shows a 6% increase in accuracy over VAE and a 66% reduction in DP, an 85% reduction in EO, and a 45% reduction in EOp compared to FADE.

Further, the generation quality of the proposed approach can be evaluated in two domains such as generalization and representation of sensitive groups with respect to actual data and synthetic data generated using TabDDPM. Generalization is evaluated using two metrics, such as Fidelity and Privacy.

In terms of fidelity and privacy, the proposed approach outperforms for adult dataset. For the bank marketing dataset, the proposed approach demonstrates superior performance in terms of fairness for generated data. All the fairness metrics, such as D-fair, SP, and coefficient correlation of auxiliary prediction task, have better values than actual data and TabDDPM. This underlines the fact that the proposed approach excels in generating fair data. In a non-limiting example, the fairness metrics achieved by TabDDPM and the proposed approach are provided in Table 6 given below:

TABLE 6
Fairness metrics achieved by the proposed approach and the TabDDPM.

| | Adult Dataset | | | Banking Dataset | | |
|---|---|---|---|---|---|---|
| | Actual | | Proposed | Actual | | Proposed |
| Metrics | Data | TabDDPM | approach | Data\| | TabDDPM | approach |
| SP | 0.194 | 0.114 | 0.008 | 0.02 | 0.009 | 0.003 |
| AP ↓ | 0.355 | 0.26 | 0.09 | 0.153 | 0.130 | 0.124 |
| D fair ↓ | — | 0.565 | 0.007 | — | 0.13 | 0.05 |
| Fidelity | — | 0.61 | 0.57 | — | 0.76 | 0.78 |
| ↓ | | | | | | |
| Privacy | — | 1.87 | 1.93 | — | 1.64 | 1.42 |
| ↑ | | | | | | |

Further, ablation studies are conducted to evaluate the individual effect of the embedding smoothening and the representational blending on the performance of the diffusion model 220. The embedding smoothing enhances fairness by generating mixed representations of sensitive groups in the input to the diffusion model 220. Since the diffusion model 220 is unable to discern sensitive attributes, it produces an equal representation of these groups. While this improves fairness metrics compared to the baseline diffusion model, it does not fully mitigate the indirect bias present in the dataset. On the other hand, representation blending results in lower fairness metrics while significantly degrading generalization. Due to the high bias in the input, the blending process excessively merges representations during the forward pass. Consequently, the reverse process struggles to learn effectively, leading to poor-quality synthetic data. The best performance, in terms of both generalization and fairness, is achieved when the embedding smoothing and the representation blending are used in conjunction. This synergy effectively balances fairness while preserving the generalizability of the generated data.

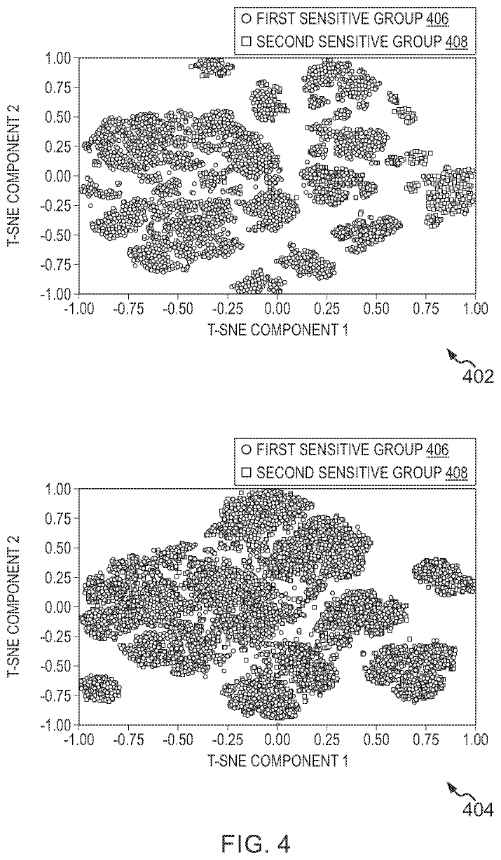

FIG. 4 illustrates t-Distributed Stochastic Neighbor Embedding (t-SNE) plots depicting feature distribution of the actual positive class dataset and the generated positive class dataset, in accordance with an implementation of the present disclosure. The t-SNE plots can be utilized to evaluate whether the feature distribution for the positive class is preserved after the embedding smoothing and the representation blending. In an experiment, two t-SNE plots were generated for data containing sensitive groups. These t-SNE plots provide insights regarding the distributions of the data.

A first plot 402, depicts the positive class distribution of two sensitive groups, such as a first sensitive group 406 and a second sensitive group 408, before the embedding smoothing and the representation blending. It is observed that the positive classes are non-uniformly distributed before the embedding smoothing and the representation blending.

A second plot 404, depicts the positive class distribution of the first sensitive group 406 and the second sensitive group 408 after the embedding smoothing and the representation blending. It may be observed that the positive classes are uniformly distributed before the embedding smoothing and the representation blending. This indicates that, the diffusion model 220 achieves fairness by performing the embedding smoothing and the representation blending.

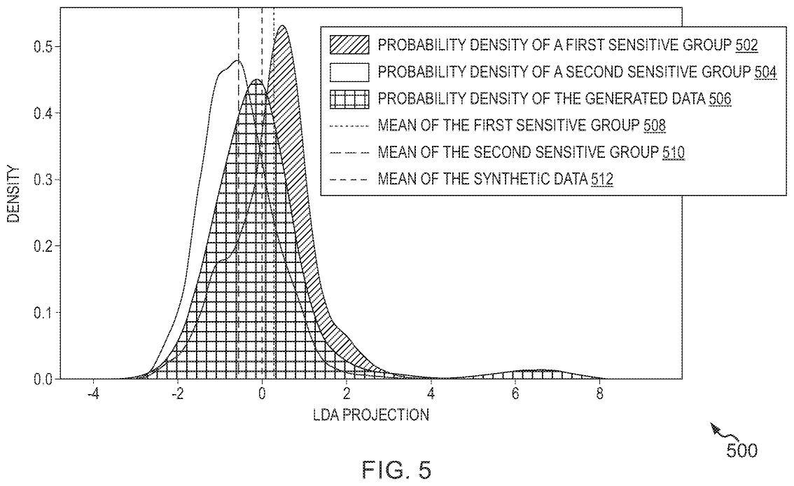

FIG. 5 illustrates Linear Discriminant Analysis (LDA) plot 500 of an adult dataset and a synthetic dataset, in accordance with an implementation of the present disclosure. The synthetic dataset is generated using the proposed approach. To assess fairness across the entire dataset, the probability density in one dimension for the adult dataset and the generated dataset (i.e., synthetic dataset) is estimated using Linear Discriminant Analysis (LDA). More specifically, the probability density of a first sensitive group 502 and the probability density of a second sensitive group 504 belonging to the adult dataset is plotted along with the probability density of the synthetic dataset 506. It may be observed from the LDA plot 500 that, a mean 512 of the probability density of the synthetic dataset 506 falls between a mean 508 of the probability density of the first sensitive group 502 and a mean 510 of the probability density of the second sensitive group 504, indicating fair data generation for both the positive and negative classes of the adult dataset. This underlines the capability of the proposed approach to generate the fair synthetic data.

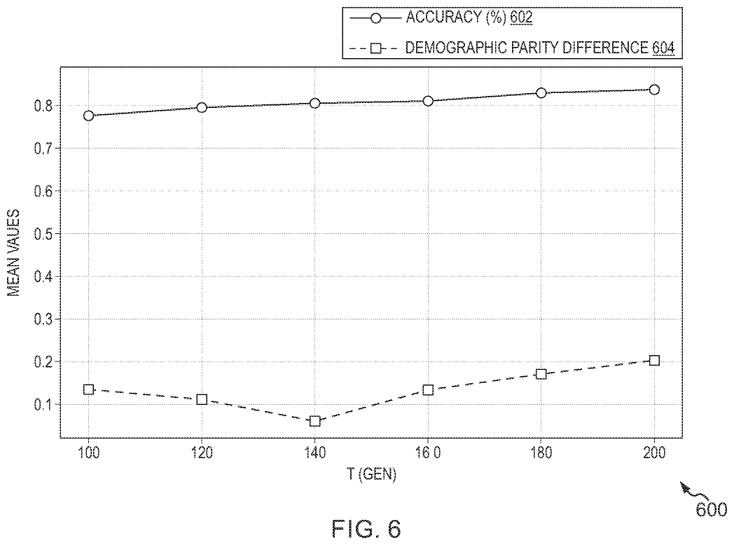

FIG. 6 illustrates a graph 600 depicting accuracy 602 and fairness 604 (i.e., DP difference) of the synthetic data generated for different generation timesteps, in accordance with an implementation of the present disclosure. From the graph 600, it can be seen that the accuracy 602 increases and becomes constant after a specific timestep (i.e., 180). On the other hand, the fairness 604 increases as the time stamp increases. For training the diffusion model 220, the timestep can be selected appropriately to achieve the desired accuracy and fairness.

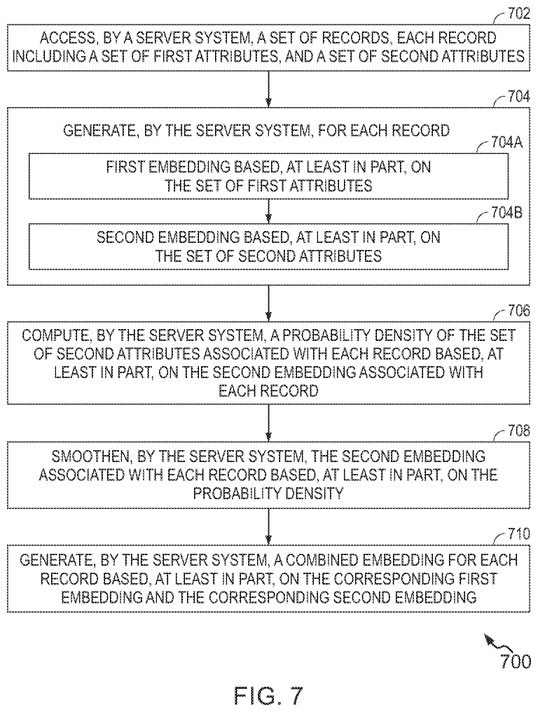

FIG. 7 illustrates a process flow diagram depicting a method 700 for generating the combined embedding, in accordance with an implementation of the present disclosure. The method 700 depicted in the flow diagram may be executed by, for example, the server system 200. The sequence of operations of the method 700 may not be necessarily executed in the same order as they are presented. Further, one or more operations may be grouped and performed in the form of a single step, or one operation may have several sub-steps that may be performed in parallel or in a sequential manner. Operations of the method 700, and combinations of operations in the method 700, may be implemented by, for example, hardware, firmware, a processor, circuitry, and/or a different device associated with the execution of software that includes one or more computer program instructions. The plurality of operations is depicted in the process flow of the method 700. The process flow starts at operation 702.

At operation 702, the method 700 includes accessing, by a server system such as the server system 200, a set of records such as the set of records 218, each record including a set of first attributes, and a set of second attributes.

At operation 704, the method 700 includes generating, by the server system 200, for each record a first embedding and a second embedding. Generating the first embedding and the second embedding include performing the following set of operations i.e., 704A to 704B.

At operation 704A, the method 700 includes generating the first embedding based, at least in part, on the set of first attributes.

At operation 704B, the method 700 includes generating the second embedding based, at least in part, on the set of second attributes.

At operation 706, the method 700 includes computing, by the server system 200, a probability density of the set of second attributes associated with each record for the set of records 218 based, at least in part, on the second embedding associated with each record.

At operation 708, the method 700 includes smoothening, by the server system 200, the second embedding associated with each record based, at least in part, on the probability density. Herein, smoothening the second embedding associated with each record minimizes distinguishability between different second attributes associated with each record for the set of records 218.

At operation 710, the method 700 includes generating, by the server system 200, a combined embedding for each record based, at least in part, on the corresponding first embedding and the corresponding second embedding.

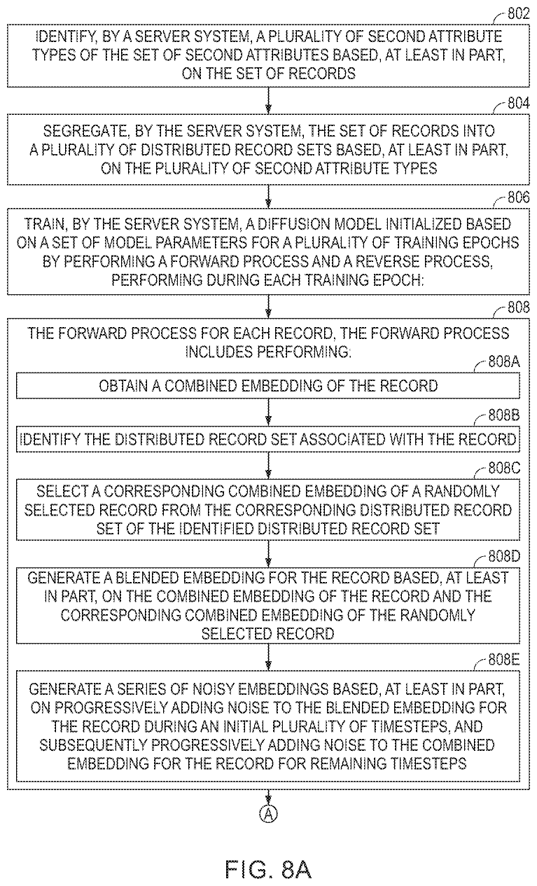

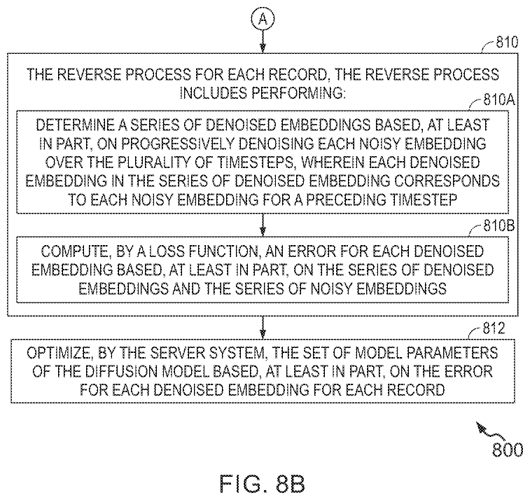

FIG. 8A and FIG. 8B, collectively, illustrate a process flow diagram depicting a method 800 for training a diffusion model such as the diffusion model 220, in accordance with an implementation of the present disclosure. The method 800 depicted in the flow diagram may be executed by, for example, the server system 200. The sequence of operations of the method 800 may not be necessarily executed in the same order as they are presented. Further, one or more operations may be grouped and performed in the form of a single step, or one operation may have several sub-steps that may be performed in parallel or in a sequential manner. Operations of the method 800, and combinations of operations in the method 800, may be implemented by, for example, hardware, firmware, a processor, circuitry, and/or a different device associated with the execution of software that includes one or more computer program instructions. The plurality of operations is depicted in the process flow of the method 800. The process flow starts at operation 802.

At operation 802, the method 800 includes identifying, by a server system such as the server system 200, a plurality of second attribute types of the set of second attributes based, at least in part, on the set of records 218.

At operation 804, the method 800 includes segregating, by the server system 200, the set of records 218 into a plurality of distributed record sets based, at least in part, on the plurality of second attribute types. Herein, each distributed record set includes a subset of records associated with a subset of second attributes of a particular second attribute type. Herein, each distributed record set has a corresponding distributed record set, including a distinct subset of records associated with a distinct second attribute type.

At operation 806, the method 800 includes training, by the server system 200, a diffusion model 220 for a plurality of training epochs based, at least in part, on a forward process and a reverse process. Here, the diffusion model 220 is initialized based on a set of model parameters. Each training epoch performs the following set of operations i.e., 808, 810, and 812.

At operation 808, the method 800 includes performing, by the diffusion model 220, the forward process for each record. Performing the forward process includes the following set of operations i.e., 808A to 808E.

At operation 808A, the method 800 includes obtaining the combined embedding of the record.

At operation 808B, the method 800 includes identifying the distributed record set associated with the record.

At operation 808C, the method 800 includes selecting a corresponding combined embedding of a randomly selected record from the corresponding distributed record set of the identified distributed record set.

At operation 808D, the method 800 includes generating a blended embedding for the record based, at least in part, on the combined embedding of the record and the corresponding combined embedding of the randomly selected record.

At operation 808E, the method 800 includes generating a series of noisy embeddings based, at least in part, on progressively adding noise to the blended embedding for the record during an initial plurality of timesteps, and subsequently progressively adding noise to the combined embedding for the record for remaining timesteps. Herein, each noisy embedding in the series of noisy embedding is associated with a particular timestep from the plurality of timesteps.

At operation 810, the method 800 includes performing by the diffusion model 220, the reverse process. Performing the reverse process includes the following set of operations i.e., 810A to 810C.

At operation 810A, the method 800 includes determining a series of denoised embeddings based, at least in part, on progressively denoising each noisy embedding over the plurality of timesteps, wherein each denoised embedding in the series of denoised embedding corresponds to each noisy embedding for a preceding timestep. Here, the diffusion model 220 computes a predicted noise associated with each noisy embedding and uses the predicted noise to obtain the denoised embedding corresponding to a preceding timestep.

At operation 810B, the method 800 includes computing, by a loss function, an error for each denoised embedding based, at least in part, on the series of denoised embeddings and the series of noisy embeddings. The diffusion model 220 compares the predicted noise with an actual noise added to generate the noisy embedding at the preceding timestep, and the loss function computes the error based on the comparison between the predicted noise and the actual noise.

At operation 812, the method 800 includes optimizing, by the server system 200, the set of model parameters of the diffusion model 220 based, at least in part, on the error for each denoised embedding for each record.

The disclosed method with reference to FIG. 7 and FIGS. 8 and 8B, or one or more operations of the server system 200 may be implemented using software including computer-executable instructions stored on one or more computer-readable media (e.g., non-transitory computer-readable media, such as one or more optical media discs, volatile memory components (e.g., DRAM or SRAM), or nonvolatile memory or storage components (e.g., hard drives or solid-state nonvolatile memory components, such as Flash memory components) and executed on a computer (e.g., any suitable computer, such as a laptop computer, netbook, Web book, tablet computing device, smartphone, or other mobile computing devices). Such software may be executed, for example, on a single local computer or in a network environment (e.g., via the Internet, a wide-area network, a local-area network, a remote web-based server, a client-server network (such as a cloud computing network), or other such networks) using one or more network computers. Additionally, any of the intermediate or final data created and used during the implementation of the disclosed methods or systems may also be stored on one or more computer-readable media (e.g., non-transitory computer-readable media) and are considered to be within the scope of the disclosed technology. Furthermore, any of the software-based implementations may be uploaded, downloaded, or remotely accessed through a suitable communication means. Such a suitable communication means includes, for example, the Internet, the World Wide Web (WWW), an intranet, software applications, cable (including fiber optic cable), magnetic communications, electromagnetic communications (including RF, microwave, and infrared communications), electronic communications, or other such communication means.

Although the disclosure has been described with reference to specific exemplary implementations, it is noted that various modifications and changes may be made to these implementations without departing from the broad spirit and scope of the disclosure. For example, the various operations, blocks, etc., described herein may be enabled and operated using hardware circuitry (for example, Complementary Metal Oxide Semiconductor (CMOS) based logic circuitry), firmware, software, and/or any combination of hardware, firmware, and/or software (for example, embodied in a machine-readable medium). For example, the apparatuses and methods may be embodied using transistors, logic gates, and electrical circuits (for example, Application Specific Integrated Circuit (ASIC) circuitry and/or Digital Signal Processor (DSP) circuitry).

Particularly, the server system 200 and its various components may be enabled using software and/or using transistors, logic gates, and electrical circuits (for example, integrated circuit circuitry such as ASIC circuitry). Various implementations of the disclosure may include one or more computer programs stored or otherwise embodied on a computer-readable medium. Herein, the computer programs are configured to cause the processor or the computer to perform one or more operations. A computer-readable medium storing, embodying, or encoded with a computer program or similar language may be embodied as a tangible data storage device storing one or more software programs that are configured to cause the processor or computer to perform one or more operations. Such operations may be, for example, any of the steps or operations described herein. In some implementations, the computer programs may be stored and provided to a computer using any type of non-transitory computer-readable media. Non-transitory computer-readable media includes any type of tangible storage media.

Examples of non-transitory computer-readable media include magnetic storage media (such as floppy disks, magnetic tapes, hard disk drives, etc.), optical magnetic storage media (e.g. magneto-optical disks), Compact Disc Read-Only Memory (CD-ROM), Compact Disc Recordable (CD-R), compact disc rewritable (CD-R/W), Digital Versatile Disc (DVD), BLU-RAY® Disc (BD), and semiconductor memories (such as mask ROM, programmable ROM (PROM), (erasable PROM), flash memory, Random Access Memory (RAM), etc.).

Additionally, a tangible data storage device may be embodied as one or more volatile memory devices, one or more non-volatile memory devices, and/or a combination of one or more volatile memory devices and non-volatile memory devices. In some implementations, the computer programs may be provided to a computer using any type of transitory computer-readable media. Examples of transitory computer-readable media include electric signals, optical signals, and electromagnetic waves. Transitory computer-readable media can provide the program to a computer via a wired communication line (e.g., electric wires and optical fibers) or a wireless communication line.

Various implementations of the implementation, as discussed above, may be practiced with steps and/or operations in a different order, and/or with hardware elements in configurations, which are different than those which are disclosed. Therefore, although the implementation has been described based on these exemplary implementations, it is noted that certain modifications, variations, and alternative constructions may be apparent and well within the spirit and scope of the disclosure.

Although various exemplary implementations of the disclosure are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A computer-implemented method, comprising:
accessing, by a server system, a set of records, each record in the set of records comprising a set of first attributes, and a set of second attributes;
training, by the server system, a diffusion model initialized based on a set of model parameters for a plurality of training epochs by performing a forward process and a reverse process, performing during each training epoch:
the forward process for each record, the forward process comprising:
obtaining a combined embedding of a record;
identifying a distributed record set associated with the record;
selecting a corresponding combined embedding of a randomly selected record from the corresponding distributed record set of the identified distributed record set;
generating a blended embedding for the record based, at least in part, on the combined embedding of the record and the corresponding combined embedding of the randomly selected record; and
generating a series of noisy embeddings based, at least in part, on progressively adding noise to the blended embedding for the record during an initial subset of a plurality of timesteps, and subsequently progressively adding noise to the combined embedding for the record for remaining timesteps, each noisy embedding in the series of noisy embedding associated with a particular timestep from the plurality of timesteps;
the reverse process for each record to obtain an error for each denoised embedding for each record; and
optimizing, by the server system, the set of model parameters of the diffusion model based, at least in part, on the error for each denoised embedding for the record; and
obtaining, by the server system, a trained diffusion model after the plurality of training epochs.

2. The computer-implemented method as claimed in claim 1, wherein performing the reverse process for each record comprises:
determining a series of denoised embeddings based, at least in part, on progressively denoising each noisy embedding over the plurality of timesteps; and
computing, by a loss function, an error for each denoised embedding for the record based, at least in part, on the series of denoised embeddings and the series of noisy embeddings.

3. The computer-implemented method as claimed in claim 2, wherein determining the series of denoised embeddings comprises:
computing a predicted noise added to each noisy embedding at a preceding timestep of the plurality of timesteps to obtain the series of denoised embeddings.

4. The computer-implemented method as claimed in claim 3, wherein computing the error comprises:
comparing the predicted noise with an actual noise added to generate the noisy embedding at the preceding timestep; and
computing, by the loss function, the error for each denoised embedding based on the comparison.

5. The computer-implemented method as claimed in claim 1, wherein obtaining the combined embedding comprises:
generating for each record:
a first embedding based, at least in part, on the set of first attributes;
a second embedding based, at least in part, on the set of second attributes; and
computing a probability density of the set of second attributes associated with each record for the set of records based, at least in part, on the second embedding associated with each record.

6. The computer-implemented method as claimed in claim 5, further comprising:
smoothening the second embedding associated with each record based, at least in part, on the probability density; and
generating the combined embedding for each record based, at least in part, on the corresponding first embedding and the corresponding second embedding.

7. The computer-implemented method as claimed in claim 1, wherein identifying a distributed record set comprises:
identifying a plurality of second attribute types of the set of second attributes based, at least in part, on the set of records; and
segregating the set of records into a plurality of distributed record sets based, at least in part, on the plurality of second attribute types, each distributed record set comprises a subset of records associated with a subset of second attributes of a particular second attribute type.

8. The computer-implemented method as claimed in claim 1, further comprising:
obtaining, by the server system, a noise distribution; and
performing, by the server system, the reverse process via the trained diffusion model on the noise distribution to obtain a set of synthetic records.

9. The computer-implemented method as claimed in claim 8, further comprising:
training, by the server system, a classification model to perform downstream classification task based, at least in part, on the set of synthetic records and the set of records.

10. A server system, comprising:
a communication interface;
a memory comprising executable instructions; and
a processor communicably coupled to the communication interface and the memory, the processor configured to cause the server system to at least:
access a set of records, each record in the set of records comprising a set of first attributes, and a set of second attributes;
train a diffusion model initialized based on a set of model parameters for a plurality of training epochs by performing a forward process and a reverse process, performing during each training epoch:
the forward process for each record, the forward process comprising:
obtaining a combined embedding of a record;
identifying a distributed record set associated with the record;
selecting a corresponding combined embedding of a randomly selected record from the corresponding distributed record set of the identified distributed record set;
generating a blended embedding for the record based, at least in part, on the combined embedding of the record and the corresponding combined embedding of the randomly selected record;
generating a series of noisy embeddings based, at least in part, on progressively adding noise to the blended embedding for the record during an initial subset of a plurality of timesteps, and subsequently progressively adding noise to the combined embedding for the record for remaining timesteps, each noisy embedding in the series of noisy embedding associated with a particular timestep from the plurality of timesteps;
the reverse process for each record to obtain an error for each denoised embedding for each record; and
optimize the set of model parameters of the diffusion model based, at least in part, on the error for each denoised embedding for the record; and
obtain a trained diffusion model after the plurality of training epochs.

11. The server system as claimed in claim 10, wherein to perform the reverse process for each record, the server system is caused, at least in part, to:
determine a series of denoised embeddings based, at least in part, on progressively denoising each noisy embedding over the plurality of timesteps; and
compute, by a loss function, an error for each denoised embedding for the record based, at least in part, on the series of denoised embeddings and the series of noisy embeddings.

12. The server system as claimed in claim 11, wherein to determine the series of denoised embeddings, the server system is caused, at least in part, to:
compute a predicted noise added to each noisy embedding at a preceding timestep of the plurality of timesteps to obtain the series of denoised embeddings.

13. The server system as claimed in claim 12, wherein to compute the error, the server system is caused, at least in part, to:
compare the predicted noise with an actual noise added to generate the noisy embedding at the preceding timestep; and
compute, by the loss function, the error for each denoised embedding based on the comparison.

14. The server system as claimed in claim 10, wherein to obtain the combined embedding, the server system is caused, at least in part, to:
generate for each record:
a first embedding based, at least in part, on the set of first attributes;
a second embedding based, at least in part, on the set of second attributes; and
compute a probability density of the set of second attributes associated with each record for the set of records based, at least in part, on the second embedding associated with each record.

15. The server system as claimed in claim 14, wherein the server system is further caused, at least in part, to:
smoothen the second embedding associated with each record based, at least in part, on the probability density; and
generate the combined embedding for each record based, at least in part, on the corresponding first embedding and the corresponding second embedding.

16. The server system as claimed in claim 10, wherein to identify a distributed record set the server system is caused, at least in part, to:
identify a plurality of second attribute types of the set of second attributes based, at least in part, on the set of records; and
segregate the set of records into a plurality of distributed record sets based, at least in part, on the plurality of second attribute types, each distributed record set comprises a subset of records associated with a subset of second attributes of a particular second attribute type.

17. The server system as claimed in claim 10, wherein the server system is further caused, at least in part, to:
obtain a noise distribution; and
perform the reverse process via the trained diffusion model on the noise distribution to obtain a set of synthetic records.

18. The server system as claimed in claim 17, wherein the server system is further caused, at least in part, to:
train a classification model to perform downstream classification task based, at least in part, on the set of synthetic records and the set of records.

19. A non-transitory computer-readable storage medium comprising computer-executable instructions that, when executed by at least a processor of a server system, cause the server system to perform a method comprising:
accessing a set of records, each record in the set of records comprising a set of first attributes, and a set of second attributes;
training a diffusion model initialized based on a set of model parameters for a plurality of training epochs by performing a forward process and a reverse process, performing during each training epoch:
the forward process for each record, the forward process comprising:
obtaining a combined embedding of a record;
identifying a distributed record set associated with the record;
selecting a corresponding combined embedding of a randomly selected record from the corresponding distributed record set of the identified distributed record set;
generating a blended embedding for the record based, at least in part, on the combined embedding of the record and the corresponding combined embedding of the randomly selected record;
generating a series of noisy embeddings based, at least in part, on progressively adding noise to the blended embedding for the record during an initial subset of a plurality of timesteps, and subsequently progressively adding noise to the combined embedding for the record for remaining timesteps, each noisy embedding in the series of noisy embedding associated with a particular timestep from the plurality of timesteps;
the reverse process for each record to obtain an error for each denoised embedding for each record; and
optimizing the set of model parameters of the diffusion model based, at least in part, on the error for each denoised embedding for the record; and
obtaining a trained diffusion model after the plurality of training epochs.

20. The non-transitory computer-readable storage medium as claimed in claim 19, wherein performing the reverse process for each record comprises:
determining a series of denoised embeddings based, at least in part, on progressively denoising each noisy embedding over the plurality of timesteps; and
computing, by a loss function, an error for each denoised embedding for the record based, at least in part, on the series of denoised embeddings and the series of noisy embeddings.
